(19) United States
(12) Patent Application Publication
(10) Pub. No.: US 2026/0299664 A1
(43) Pub. Date: Oct. 1, 2026

(54) Transponder Subsystem for Power Management

(71) Applicant: Apple Inc., Cupertino, CA (US)

(72) Inventors: Roey Grinvald, Ramat Gan (IL); Shhadi Naamneh, Arraba (IL); Tzach Zemer, Haifa (IL); Jason C. Wei, Milpitas, CA (US); Shawn M. Fukami, Newark, CA (US)

(21) Appl. No.: 19/314,630

(22) Filed: Aug. 29, 2025

Related U.S. Application Data
(60) Provisional application No. 63/779,572, filed on Mar. 28, 2025.

(51) Int. Cl. G06F 1/3209

(52) U.S. Cl. CPC G06F 1/3209

(57) ABSTRACT

A computer system that includes a plurality of agent circuits and a network circuit configured to convey information between the agent circuits. The network circuit includes a plurality of network circuit elements coupled via a plurality of links to define a network topology having respective network paths between pairs of the plurality of agent circuits and a transponder subsystem. The transponder subsystem is configured to deactivate links of the plurality of links based on determinations of network inactivity for network paths that utilize those links, and activate deactivated links in a particular network path based on an indication of network activity for a first pair of agent circuits that utilize the particular network path. The computer system is configured to reduce power to links that have been deactivated.

The present application claims priority to U.S. Provisional App. No. 63/779,572, entitled “Transponder Subsystem for Power Management,” filed Mar. 28, 2025, the disclosure of which is incorporated by reference herein in its entirety.

### BACKGROUND

### Technical Field

This disclosure relates generally to computer systems, and more generally to managing power within networks within such computer systems.

### Description of the Related Art

Computer interconnects, often referred to as fabrics, are networks that enable communication between various components within a computer system, such as CPUs, memory, storage, and networking devices. These interconnects are designed to facilitate high-speed data transfer, ensuring that information flows seamlessly across the system to support efficient processing and application performance. Various types of interconnects exist, including point-to-point connections, bus-based systems, and more advanced topologies like mesh and toroidal networks.

### BRIEF DESCRIPTION OF THE DRAWINGS

FIG. 1 is a block diagram of one embodiment of a computer system that includes a network circuit with a transponder subsystem for power management.

FIG. 2 is a block diagram of one embodiment of a network circuit of a computer system that illustrates connections between a central transponder circuit and follower transponder circuits of a transponder subsystem.

FIG. 3A is a block diagram of one embodiment of a central transponder circuit.

FIG. 3B illustrates a diagram for one embodiment of a lock state machine within a central transponder circuit.

FIG. 3C is one example of a lock table within a central transponder circuit.

FIG. 3D illustrates a diagram for one embodiment of a teardown state machine within a central transponder circuit.

FIG. 4 illustrates interfaces of one embodiment of a follower transponder circuit.

FIG. 5 is a flow diagram illustrating one embodiment of link teardown within a computer network with a transponder subsystem.

FIG. 6 is a flow diagram illustrating one embodiment of link wakeup within a computer network with a transponder subsystem.

FIG. 7A is a block diagram of one embodiment of a network circuit in which multiple central transponder circuits are located on a single integrated circuit die.

FIG. 7B is a block diagram of one embodiment of a network circuit located on two different integrated circuit dies, each having a corresponding central transponder circuit.

FIG. 8 illustrates one embodiment of a network circuit with network paths spanning multiple integrated circuit dies.

FIG. 9 depicts tables illustrating operation of one embodiment of a multiple central transponder subsystem.

FIG. 10A is a block diagram of one embodiment of a transponder subsystem with multiple central transponder circuits.

FIG. 10B is a flow diagram of one embodiment of a method for a teardown flow for a transponder subsystem with multiple central transponder circuits.

FIG. 10C is a flow diagram of one embodiment of a method for a wakeup flow for a transponder subsystem with multiple central transponder circuits.

FIG. 11A is a flow diagram of one embodiment of a method for using a transponder subsystem to manage a network circuit.

FIG. 11B is a flow diagram of one embodiment of a method for using a transponder subsystem with multiple central transponder circuits to manage a network circuit.

FIG. 12 is a block diagram of one embodiment of a computer system.

FIG. 13 is a diagram illustrating example applications for systems and devices employing the disclosed techniques.

FIG. 14 is a block diagram illustrating an example computer-readable medium that stores circuit design information for implementing devices that employ the disclosed techniques.

### DETAILED DESCRIPTION

One prominent design consideration for computer system interconnects is reliability. In some computer designs, for example, data communication over an internal network may have an end-to-end guarantee. In other words, every transaction that enters the network has a place to sync as it travels throughout the network, thus minimizing the chance of “backpressure” within the network that could cause resource starvation such as a livelock or deadlock. Reliability constructs such as an end-to-end guarantee can also provide high levels of performance to the entities within the computer system that are utilizing an internal network.

Another design consideration for computer system interconnects is power management. Given the relative size and complexity of modern computer interconnects, efficient power management techniques are important to minimize energy consumption. This emphasis is particularly important in computer systems in which battery life is at a premium (e.g., mobile computing platforms).

Two power-saving techniques are clock gating and power gating. Clock gating selectively stops clock signals to inactive components, while power gating cuts off power to entire blocks when they are not in use. Both approaches thus reduce dynamic and static power consumption. These approaches target different types of power waste: power gating cuts off voltage to inactive blocks, while clock gating stops clock signals to unused components. Power gating offers more significant savings but has longer wake-up times; clock gating is faster but less effective for leakage power. Clock and power gating may be utilized within a computer system interconnect. If no power is detected within a particular power domain of a network, that portion may be clock gated and then subsequently power gated to reduce power consumption of the network.

Clock and power gating (CPG) within a computer system interconnect present challenges with respect to reliability measures such as an end-to-end guarantee. For example, consider the gating of a network link that is currently being utilized by one or more sources/destinations within the computer system. Such gating would mean that a transaction may be sent to the network while links in the path between the source and destination are unavailable, resulting in a backpressure.

The present inventors have recognized that the dual goals of reliability and power management of a computer network may both be achieved through use of controller circuitry (referred to as a “transponder subsystem” throughout this disclosure) that is able to verify the activity or inactivity of particular portions of the network before making a power management decision. As will be described, a transponder subsystem can verify that all network paths that utilize a particular link of the network are inactive before deactivating the particular link and performing CPG. A transponder subsystem can also be used to activate all portions of a particular network path when that path has traffic, and to stall the traffic until the particular network path is available.

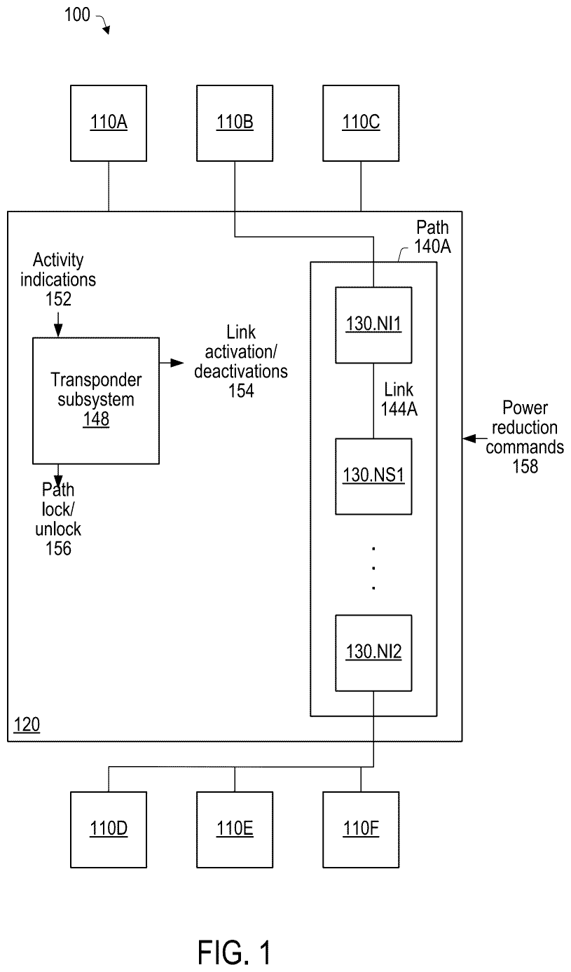

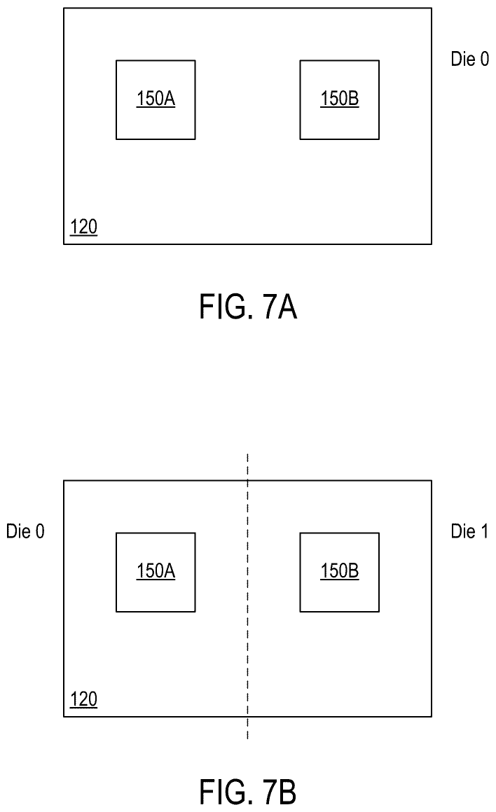

Transponder subsystems described herein have one or more “central transponder circuits” for a given network circuit. Embodiments with a single central transponder circuit are described with respect to FIGS. 1-6. Embodiments with multiple central transponder circuits, in which each central transponder circuit is responsible for a particular portion of the network circuit, are described with respect to FIGS. 7-10.

FIG. 1 is a block diagram of one embodiment of a computer system that includes a network circuit with a transponder subsystem for power management. As depicted, computer system 100 includes a plurality of agent circuits 110A-F and a network circuit 120. Network circuit 120 includes a transponder subsystem 148 and a plurality of network elements 130, which are coupled by links 144 (one of which is shown as link 144A).

Agent circuits refer to any source or destination of traffic that is directed over network circuit 120. Agent circuits can have heterogeneous functionality within computer system 100 (that is, there may be different types of agent circuits such as processor circuits, memory controller, graphics processing units, etc.). More detail regarding agent circuits is provided below in the section entitled “Agent Circuits.”

Network circuit 120 refers to any suitable type/topology of system interconnect. In one embodiment, network circuit 120 may be a mesh network. In some cases, network circuit 120 may be referred to as a “computer fabric” or “fabric.” Note that while only network circuit 120 is shown in FIG. 1 for convenience, a given computer system may have multiple computer networks, each with its own corresponding transponder subsystem in some cases.

In one embodiment, network circuit 120 includes a plurality of network circuit elements coupled together. The network circuit elements (collectively, network circuit elements 130) may include network interface (NI) circuits and network switch (NS) circuits. NI circuits (e.g., 130.NI1 and 130.NI2) refer to circuits of network circuit 120 that couple to a source or destination agent circuit. In some embodiments, a particular agent circuit may have a corresponding NI circuit for each possible agent circuit the particular agent circuit is configured to communicate with. Alternatively, a single NI circuit for the particular agent circuit may include different portions for different agent circuits the particular agent circuit is in communication with. NS circuits 130 (e.g., 130.NS1) are coupled together to define a particular network topology (e.g., what agent circuits can communicate and via what type of route). A connection between a pair of agent circuits is referred to as a “network path.” Network circuit 120 has a plurality of network paths 140, including representative network path 140A between agent circuit 110B and agent circuit 110E.

A given network path includes a plurality of links 144. A given link refers to the physical connection between two network circuit elements (e.g., NI→NS, NS→NS, NS→NI). For example, link 144A couples 130.NI1 to 130.NS1. As will be described, CPG can be performed on links 144, meaning that the links support deactivation (also referred to as “teardown”). Links 144 also support the reverse process of activation or reactivation (also referred to as “wakeup”). Note that in some embodiments, links can be bidirectional, while in other embodiments, links are unidirectional, such that there are two links (upstream and downstream) between a pair of network circuit elements.

As depicted, transponder subsystem 148 is configured to receive activity indications 152 that indicate whether particular network paths are currently active. In one embodiment, activity indications 152 may be received from agent circuit NIs. In response to activity indications 152, transponder subsystem 148 may determine that all network paths that utilize a particular link are currently inactive. In such a scenario, transponder subsystem 148 is configured to initiate path lock/unlock signals 156 to lock these network paths. “Locking” a path, within the context of this disclosure, refers to ensure that no traffic can be sent or received on this path until the path is subsequently “unlocked.” Locking all paths that utilize a particular link is a prerequisite to deactivating the particular link (e.g., using link activations/deactivation signals 154).

Once a particular link is deactivated, computer system 100 may issue power reduction commands 158 to a portion of an integrated circuit that includes the particular link. In one embodiment, computer system 100 includes multiple power domains. A power domain is a collection of circuits that use the same power supply, and thus can be controlled separately from other power domains. In some embodiments, the power reduction commands may specify to clock gate and/or power gate the power domain that includes the particular link. A power management circuit (PMC), not pictured in FIG. 1, may be the source of power reduction commands 158 in one embodiment.

In a reverse process, activity indications 152 may also indicate to transponder subsystem 148 that one or more network paths that are currently locked have pending activity (e.g., traffic that needs to be sent over those paths). In this case, link activation signals 154 can be used to initiate a wakeup of those links. Once woken up, these paths may be unlocked and can resume carrying traffic.

Transponder subsystem 148, the details of which are discussed in subsequent figures, can be used to ensure the inactivity or activity of various portions of network circuit 120 before performing power reduction commands 158. In this manner, network circuit 120 is able to provide reliability guarantees while still managing power consumption of network circuit 120.

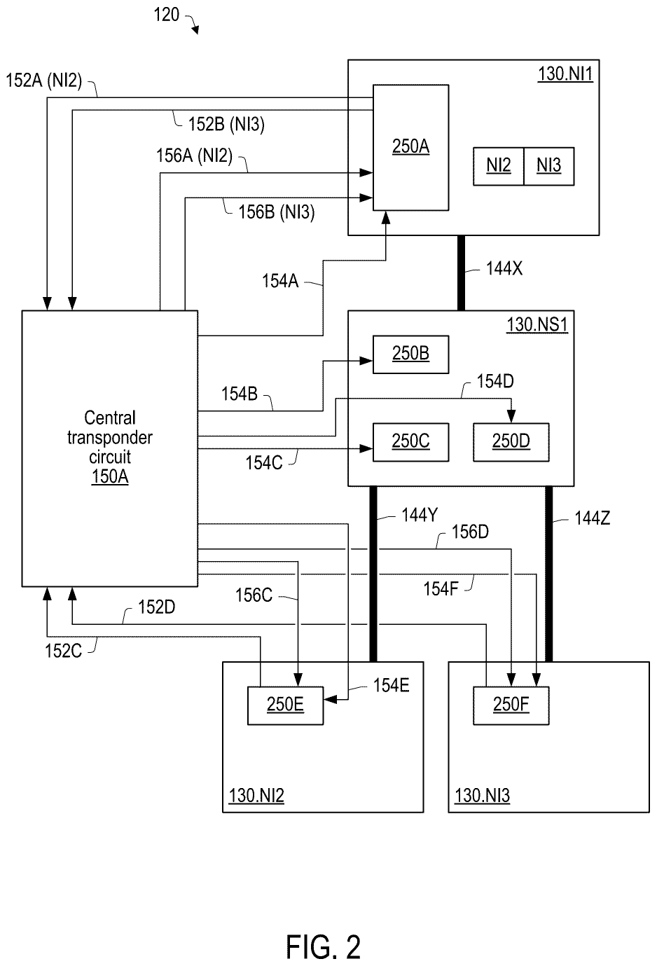

FIG. 2 is a block diagram of one embodiment of a transponder subsystem within a network circuit of a computer system. As depicted, network circuit 120 includes a central transponder circuit 150A and a plurality of follower transponder circuits 250A-F. Follower transponder circuits 250 are located in various network circuits elements 130, which are coupled together via links 144X-Z. There are two network paths shown in FIG. 2, since traffic may flow from 130.NI1 to either 130.NI2 or 130.NI3. The path from 130.NI1 to 130.NI2 includes links 144X and 144Y, while the path from 130.NI1 to 130.NI2 includes links 144X and 144Z. Transponder subsystem 148 includes both central transponder circuit 150A and follower transponder circuits 250. As will be described, the two types of transponder circuits perform different functions, but work in concert to determine and manage the status of various portions of network circuit 120.

Follower transponder circuits 250 provide local status information to central transponder circuit 150A and perform local actions such as path locking in response to commands from central transponder circuit 150A. Note that in FIG. 2, a given network element 130 has as many follower transponder circuits as it has links coupled to it. Thus 130.NS1 has three follower transponder circuits 250B-D (corresponding to links 144X-Z, respectively), while 130.NI1 has follower transponder circuit 250A (corresponding to link 144X).

Central transponder circuit 150A is configured to deactivate and reactivate different portions of network circuit 120 based on information such as activity indications 152 which originate from injection points (not pictured) to NIs. Note that an “injection point” refers to a source that sends data to a particular network interface. Follower transponder circuits 250 shown in FIG. 2 act as mediators between central transponder circuit 150A and the injection points and links of the local node. Follower transponder circuits 250 are configured to broadcast requests from central transponder circuit 150A toward multiple links/injection points, as well as to aggregate responses (e.g., activity indications) before sending them back to central transponder circuit 150A.

from follower transponder circuits 250, such as activity indications 152.

Accordingly, in one embodiment, follower transponder circuit 250A may send activity indications 152A and 152B, which originate from injection points (not depicted in FIG. 2) to central transponder circuit 150A. The former signal indicates activity or inactivity for the network path NI1→NI2, while the latter signal indicates activity or inactivity for the network path NI1→NI3.

Two types of outputs from central transponder circuit 150A are shown in FIG. 2. First, central transponder circuit 150A can issue path lock/unlock signals 156 to attempt to lock or unlock a given path. For example, a particular path such as NI1→NI2 may be attempted to be locked via signal 156A in response to receiving indications of inactivity via signals 152A and 152C. Furthermore, central transponder circuit 150A, in response to receiving acknowledgement signals (e.g., ack or nack, not pictured) that are responsive to lock signals 156, can signal to deactivate or teardown a given link via link deactivation signals 154. (As used herein, an “ack” refers to a positive acknowledgement, while a “nack” refers to a negative acknowledgement that will prevent the condition being requested.) The same signals can also be used to reactivate a link in some embodiments.

Consider an example in which 130.NI2 becomes idle and 130.NI3 is non-idle. An indication of link activity is generated by an injection point to 130.NI2 (here, indicating inactivity) and is sent to central transponder circuit 150A via signal 152C. Additionally, an indication of link activity for the NI1→NI2 flow is sent to central transponder circuit 150A via signal 152A. If both signals indicate inactivity, central transponder circuit 150A attempts to lock the NI1→NI2 path by issuing lock signal 156A (which is specific to the NI2 path) and 156C to follower transponder circuits 250A and 250E, respectively. In response, 130.NI2 locks for upstream activity (i.e., toward 130.NI1), but does not yet perform link teardown; additionally, follower transponder circuit 250E acknowledges lock request 156C. Similarly, 130.NI1 locks for downstream activity (i.e., toward 130.NI2), but does not yet perform link teardown; additionally, follower transponder circuit 250A acknowledges lock signal 156A.

Based on acks to the lock requests, central transponder circuit 150A then determines which interfaces can be torn down based on the flows that were locked (i.e., receiving acks for all node locks for a particular flow). Central transponder circuit 150A then sends, in parallel, a link deactivation request via signals 154 to all portions of the NI1→NI2 path that can be torn down. Note that 130.NI1 does not receive a teardown request, since the NI1→NI3 path is still active. Similarly, 130.NS1 does not receive teardown requests for links 144X and 144 Z because the NI1→NI3 path is active. But 130.NS1 does receive a teardown request for 144Y since the NI1→NI2 path is locked.

Note that the NI1→NI2 path is defined as inactive only when both injection points for the path (i.e., the downstream NI1→NI2 path and the upstream NI2→NI1 path) are locked. Note that in some implementations, 130.NI1 may have two injection points, one for NI1→NI2 and one for NI1→NI2. But if 130.NI1 has one injection point for both paths, the links between 130.NI1 to either 130.NI2 or 130.NI3 can be de-activated only when both paths are locked.

Note that in some embodiments, the actual lock handshake is between central transponder 150A and the injection points. Follower transponder circuits act as mediators in this regard, and have the ability, in some cases, to do a broadcast/aggregation of a single lock to multiple injection points. But if this functionality is not needed, the lock occurs directly between central transponder circuit 150A and the injection points.

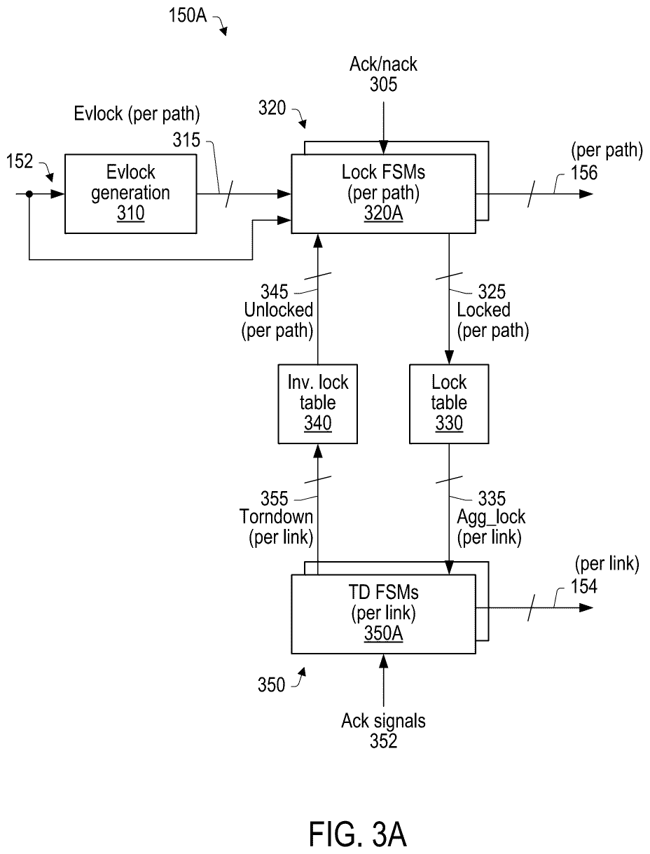

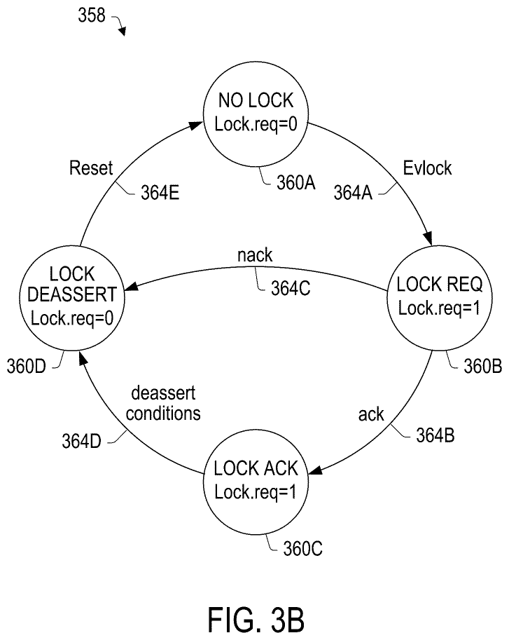

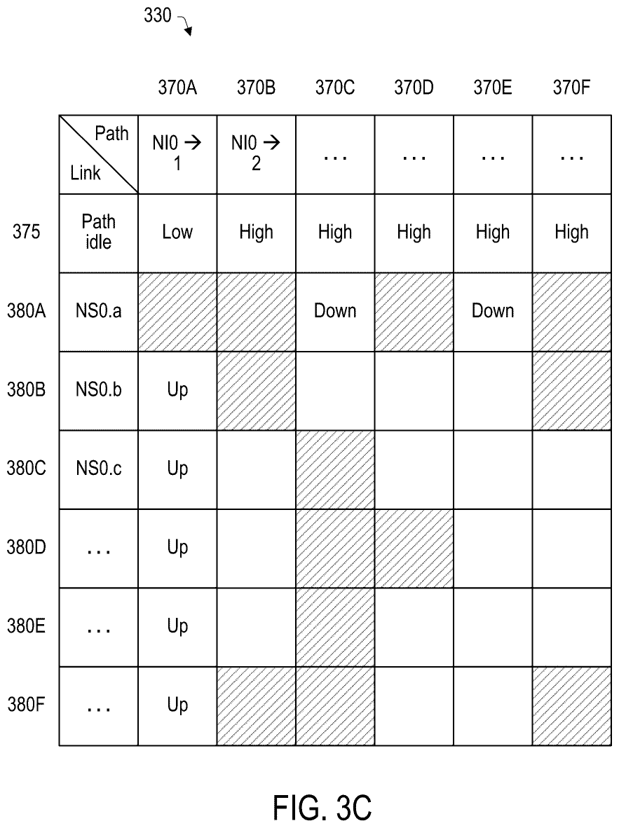

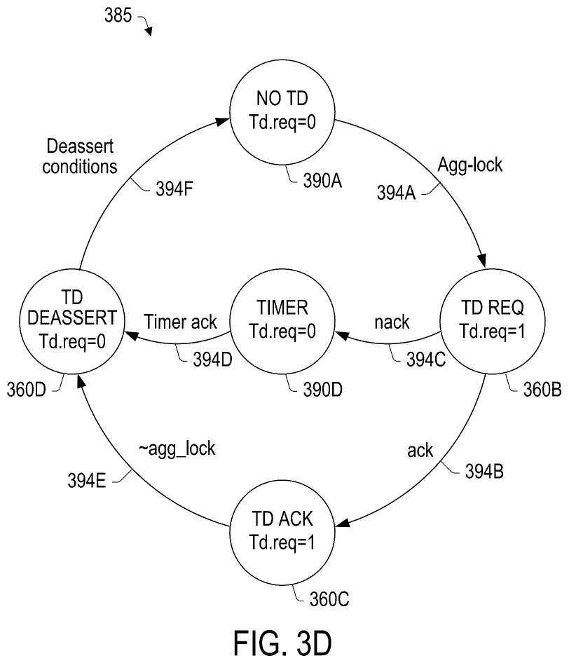

FIG. 3A is a block diagram of one embodiment of a central transponder circuit. As depicted, central transponder circuit 150A includes evlock (event lock) generation circuit 310, lock finite state machines (FSMs) 320 (one per path in network circuit 120), lock table 330, teardown FSMs 350 (one per link in network circuit 120), and inverse lock table 340. As will be described, central transponder circuit 150A uses activity indications 152 and ack/nack signals 305 from follower transponder circuits 250 to manage link teardown (deactivation) and wakeup (reactivation).

Evlock generation circuit 310 is used to aggregate indications of inactivity for all portions of a given path in order to determine when to attempt to lock the given path. Referring to FIG. 2, if activity indications 152A and 152C (which correspond to the edge nodes for the NI1→NI2 path) both indicate inactivity, evlock generation circuit 310 can generate an evlock signal 315 for the NI1→NI2 path indicating that an attempt can be made to lock that path. If one or more of the activity indications for a given path indicates activity for that path, then no attempt will be made to lock that path. Evlock generation circuit generates an evlock signal 315 for each network path.

Note that event lock is a low-level implementation. To generalize, central transponder circuit 150A aggregates indication activity from all injection points of a certain path. If all injection points are idle, central transponder circuit 150A begins locking the injection points.

As depicted, central transponder circuit 150A includes a lock FSM 320 for each path. The purpose of lock FSMs 320 to keep track of when a given path in network circuit 120 (e.g., NI1→NI2) is locked or unlocked. A given lock FSM 320 receives a corresponding evlock signal 315, a corresponding ack/nack signal 305, and a corresponding unlocked signal 345. A given lock FSM 320 outputs a corresponding lock request 156 and a locked signal 325. One possible embodiment of lock FSM 320 is described further with respect to FIG. 3B.

While lock FSMs 320 control whether a given path can be locked, one important goal of transponder subsystem 148 is to determine when a given link needs to be deactivated or reactivated. Lock table 330 receives locked signals 325 from each path and outputs an agg_lock (aggregate lock) signal 335 for each link. As will be described further with respect to FIG. 3C, when each path associated with a given link is locked, agg_lock is asserted for the given link. As shown, lock table 330 outputs one agg_lock signal 335 per link.

Central transponder circuit 150A also includes a teardown (TD) FSM 350 for each link in network circuit 120. The purpose of TD FSMs 350 is to keep track of when a given path is deactivated or not. A given TD FSM 350 receives agg_lock signals 335, ack signals 352, and outputs a corresponding deactivation signal 156 and a torndown signal 355. One possible embodiment of TD FSM 350 is described further with respect to FIG. 3D.

As its name suggests, inverse lock table 340 is the inverse of lock table 330. While lock table 330 receives per-path locked signals 325 to determine when a given link can be deactivated or reactivated, inverse lock table receives per-link torndown signals 355 that enable a determination of when a given path can unlocked. Inverse lock table 340 generates an unlocked signal 345 for each path that is supplied to a corresponding lock FSM 320.

In sum, in one embodiment, central transponder circuit 150A includes FSMs that control the current state of paths and links in network circuit 120. While the FSMs operate on a per-path basis (for locking) and a per-link basis (for teardown), tables 330 and 340 combine path and link information that enables central transponder circuit 150A to safely deactivate and reactivate links within network circuit 120.

FIG. 3B illustrates a diagram for one embodiment of a lock state machine within a central transponder circuit. As depicted, state machine 358 includes four possible states 360. A separate instance of state machine 358 is operated for each path in network circuit 120. The purpose of state machine 358 is to keep track of whether a particular path is currently locked or not; path locking/unlocking in turn permits a given link in network circuit 120 to be safely deactivated or reactivated without compromising network reliability guarantees.

In state 360A (NO LOCK), a given path is unlocked, and no lock has been requested (i.e., lock.req=0), typically because there is activity on the given path. When evlock signal 315 is generated for the given path, state transition 364A to state 360B (LOCK REQ) occurs. Although not pictured, the transition to state 360B causes lock signal 156 to be generated for that path and the variable lock.req is set to 1. In response, follower transponder circuit(s) 250 for that path generate either an ack (lock OK) or nack (lock not OK) response. If a nack is received, state transition 364C occurs, causing state machine 358 to move to state 360D (LOCK DEASSERT), which causes lock.req to be set to 0. State machine 358 will then undergo transition 364E after a reset period, returning to state 360A.

If, on the other hand, state machine 358 receives an ack in response to lock request 156, transition 364B occurs to state 360C (LOCK ACK), in which lock.req remains set to 1. State machine 358 remains in state 360C until deassert conditions occur, causing transition 364D to state 360D. In one embodiment, the deassert conditions for a particular path include the combination of activity for the particular path and each link in the particular path no longer have the torndown signal 355 set (as determined by inverse lock table 340).

State machine 358 may also output locked signal 325 to lock table 330 for each path. Locked signal 325 is set, in one embodiment, for a given path in one embodiment when lock.req is set, there is a corresponding ack, and there is no activity indication 152 for the path.

FIG. 3C is one example of a lock table within a central transponder circuit. As depicted, lock table 330 includes columns 370 (each column corresponding to a different path (e.g., NI0→NI1) and rows 380 (each row corresponding to a different link (e.g., a link coupled to port “a” of NS0). It is noted that some entries in table 330 at particular row/column intersections are shaded (e.g., the intersection of row 380A and column 370A). Such entries indicate that the link at that row is not part of the path corresponding to the column. For example, the link coupled to port a of NS0 is not part of the path from NI0→NI1. Table 330 also includes a path idle row 375 that indicates whether or not there is activity for that path. In the example shown in FIG. 3C, the path corresponding to column 370A is active, while the others are idle.

If a cell is valid, transponder subsystem 148 will wake up the link corresponding to the cell before unlocking the path corresponding to the cell, and lock the path corresponding to the cell before deactivating the link corresponding to the cell. For valid cells in table 330, there are two link states: 1) up—the link is up and traffic can go through it; 2) down—the link is down and traffic must not go through it. Lock table 330 is configured to generate an agg_lock signal 335 for each row. A given agg_lock 335 is considered active in one embodiment (thus making the link eligible for deactivation) when all paths in the corresponding row are indicated as idle. Conversely, if at least one path for a given row is active, agg_lock 335 for that row will be inactive. In the example of FIG. 3C, row 380A generates an active agg_lock 335, while the remaining rows generate an inactive agg_lock 335.

FIG. 3D illustrates a diagram for one embodiment of a teardown state machine within a central transponder circuit. As depicted, state machine 385 includes four possible states 390. A separate instance of state machine 385 is operated for each link in network circuit 120. The purpose of state machine 385 is to keep track of whether a particular link is currently torndown or not; this tracking in turn permits a given path in network circuit 120 to be safely reactivated without compromising network reliability guarantees.

In state 390A (NO TD), a given link is not torndown, and no teardown has been requested (i.e., td.req=0). When agg_lock signal 335 is generated for the given link, state transition 394A to state 390B (TD REQ) occurs. The variable td.req is accordingly set to 1. In response, follower transponder circuit(s) 250 for that link generate either an ack (teardown OK) or nack (teardown not OK) response. If a nack is received, state transition 394C occurs, causing state machine 385 to move to state 390D (TIMER), which causes td.req to be set to 0. State machine 385 will then undergo transition 394D after a timer expires, entering state 390E (TD DEASSERT). State machine 385 will then undergo transition 394F in response to receiving deassert conditions. In one embodiment, deassert conditions may simply correspond to a state in which ack, nack, and the timer are all inactive.

If, on the other hand, state machine 385 receives an ack in response to the td request, transition 394B occurs to state 390C (TD ACK), in which td.req remains set to 1. State machine 385 remains in state 390C until agg_lock signal 335, which initiated the teardown request, is deasserted, causing transition 394E to state 390E.

State machine 385, in one embodiment, outputs torndown signal 355 for each link in network circuit 120. Torndown signal 355 is set for a given link in one embodiment when one of the following conditions is true for the given link: agg_lock 335 is set, the ack signal is asserted, or td.req=1. Stated another way, torndown signal 355 is no longer set for a given link when td.req=0, agg_lock 335 is not set, and the ack signal is not asserted.

When a path indicates a non-idle condition (i.e., activity), central transponder circuit 150A is configured to reactivate (wakeup) all links in table 330 corresponding to the path (i.e., the non-shaded cells) and mark them as up. Central transponder circuit 150A is then configured to verify that all links are up and unlock the path.

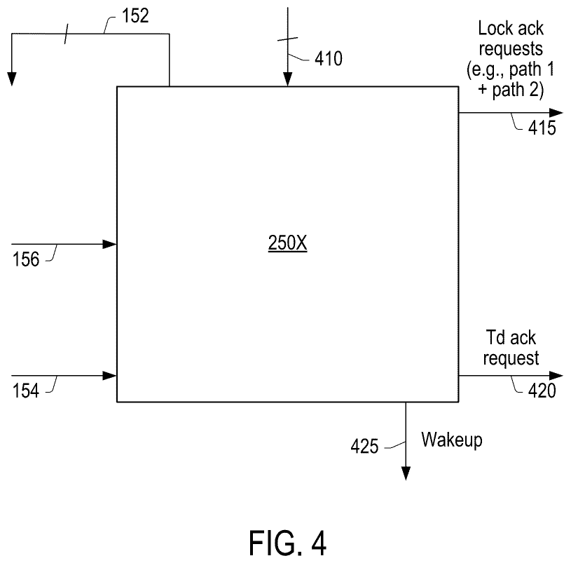

FIG. 4 illustrates interfaces of one embodiment of a follower transponder circuit. As depicted, transponder follower circuit 250X (representative of any of various follower transponder circuits 250 within network circuits) receives idle hints 410, path lock request 156, link deactivation signal 154, and outputs activity indicators 152, lock ack requests 415, teardown ack requests 420, and wakeup request 425. Generally speaking, follower transponder circuit 250 is configured to perform several functions: 1) forward information such as activity indications that ensure a particular network path is able to be locked to prevent new transactions from entering network circuit 120; 2) provide a way for the relevant links belonging only to the network path to undergo the deactivation process; 3) provide a way for the reverse process for the relevant links to wake up and unlock safely.

Idle hints 410 correspond to indications of activity from one or more paths associated with transponder follower circuit 250X. Note that these idle hints are typically generated in the first instance by injection points to a network interface. In various instances, idle hints can have different polarities (in one embodiment, a logic high can indicate idleness while a logic low can indicate activity). Idle hints 410 may originate, for example, from a portion of an NI that receives new traffic for a particular path. Note that a given follower transponder circuit 250 may receive idle hints for different paths. Transponder circuit 250 depicted in FIG. 2, for example, can receive idle hints for paths NI1→NI2 and NI1→NI3.

Idle hints 410 can be aggregated and the resulting information conveyed to central transponder circuit 150. For example, if all idle hints 410 for a given follower transponder circuit 250 indicate idleness, an activity indicator 152 may be sent that indicates such idleness. Similarly, if an idle hint 410 indicates activity for a network path that is currently deactivated, an activity indicator 152 may be sent that leads to a wakeup of the path.

As has been described, central transponder circuit 150 can send lock signal 156 upon a determination of idleness for a set of network paths that utilize a particular link. Note that the sending of lock signal 156 does not itself cause a given network path to lock. Instead, in one embodiment, follower transponder circuit 250 is configured to send one or more lock ack requests 415 to portions of the network element corresponding to the associated network path(s). For example, consider follower transponder circuit 250A, which handles the network paths NI1→NI2 and NI1→NI3. Circuit 250A will, in one embodiment, send lock ack requests for circuit portions associated with both paths. These circuit portions (not pictured) will send either an ack or nack to central transponder circuit 150, as described with respect to FIG. 3B. In some situations, both such paths may be idle, resulting in two acks being sent to central transponder circuit 150A. In other situations, one path (e.g., NI1→NI2) may be idle while another path (e.g., NI1→NI3) may be active. In the former circumstance, the two acks indicate to central transponder circuit 150 that a link associated with NI1 can begin a teardown process. In the latter case, the ack and nack may indicate that such a link cannot be torn down.

Based on the responses to lock ack requests 415, central transponder circuit 150 will decide whether to initiate tear down of a link associated with the network element that includes follower transponder circuit 250. If teardown is indicated, central transponder circuit 150 will send link deactivation signal 154. In response, follower transponder circuit 250 will initiate teardown (td) ack request 420 to circuitry (not pictured) associated with the link for which teardown is desired. As was described with respect to FIG. 3D, that circuitry will generate either an ack or nack as appropriate, depending on whether teardown can proceed.

For the link activation process, activity indicated via idle hints 410 can cause activity indication 152 to trigger central transponder circuit 150 to initiate path unlock signal 156 (in some cases, this may simply be the same signal used to indicate a path lock request, but with an opposite polarity). In response, lock ack requests 415 may again be sent out, although this time these signals indicate an unlock request. Based on responses to requests 415 indicating success (i.e., acks), central transponder circuit 150 will send link activation signal 154 to follower transponder circuit 250, which will then initiate link wakeup via wakeup signal 425.

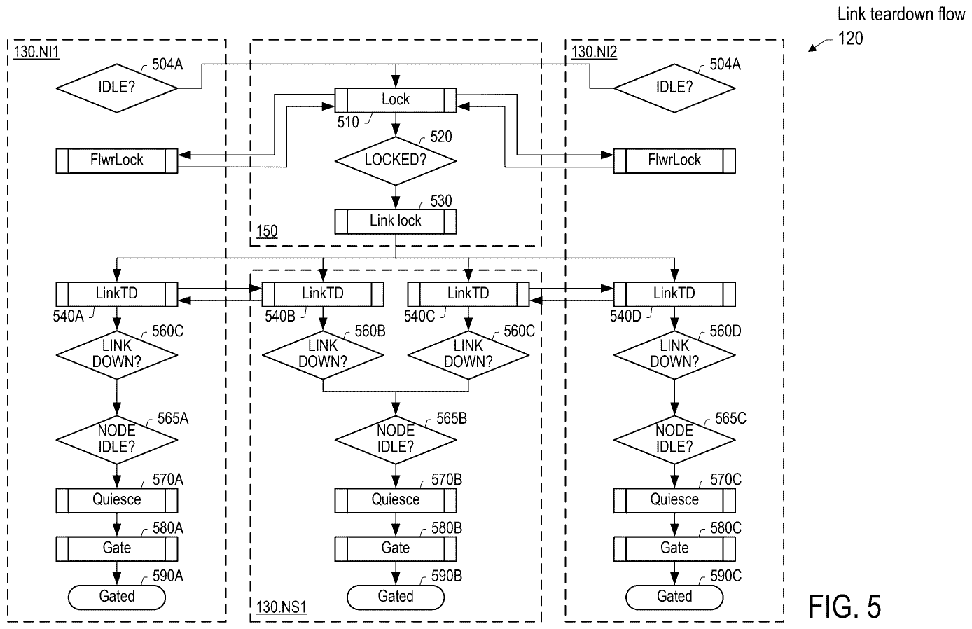

FIG. 5 is a flow diagram illustrating one embodiment of link teardown within a computer network with a transponder subsystem. As depicted, network circuit 120 includes central transponder circuit 150, network interfaces 130.NI1 and 130.NI2, and network switch 130.NS1. The diagram illustrates a path between 130.NI1 and 130.NI2 that includes links between 130.NI1 and 130.NS1 and between 130.NS1 and 130.NI2.

The teardown flow begins at 504A-B, in which 130.NI1 and 130.NI2 both indicate idleness to central transponder circuit 150. These two indications of idleness lead to lock state 510, which in turn generates lock requests at steps 514A-B to follower transponder circuits for 130.NI1 and 130.NI2. In response, acks or nacks (indicating ability or inability to lock) are sent at states 518A-B and evaluated at state 520.

If acks are received from both 130.NI1 and 130.NI2, teardown flow proceeds to link lock state 530, in which link teardown or deactivation requests are sent from central transponder circuit 150 to 130.NI1, 130.NS2, and 130.NI2 at 540A-D. Once the network elements have communicated to perform link teardown, each network element 130 proceeds to link down condition 560. Note that each network element may have multiple link interfaces (this is shown for 130.NS1, but is not pictured for 130.NI1 and 130.NI2, which may also have additional link interfaces). When all links for a given network element are down, teardown flow proceeds to state 565. After the passage of some predetermined time, each network element proceeds to a quiesce state 570, followed by gating state 580, in which clock and power gating is initiated with respect to the power domain that includes the particular network element. The result of gating state 580 is gated state 590, in which a link has not only been torn down, but also has been clock and power gated.

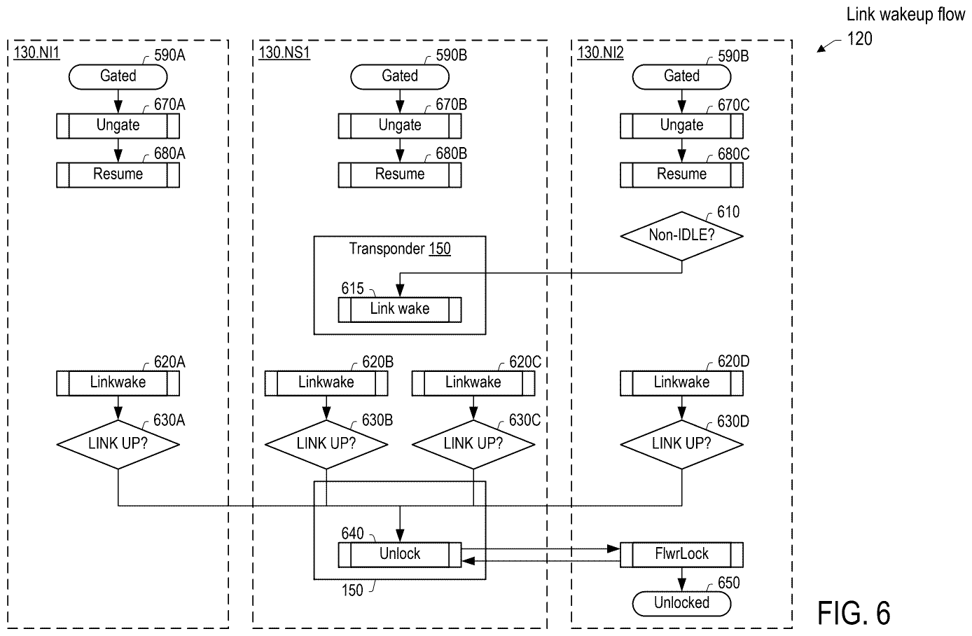

FIG. 6 is a flow diagram illustrating one embodiment of link wakeup within a computer network with a transponder subsystem. This is the reverse of the process illustrated in FIG. 5. As depicted, network circuit 120 includes central transponder circuit 150, and network elements 130.NI1, 130.NI2, and network switch 130.NS2. Each element begins in gated state 590.

The wakeup flow begins at 610, in which 130.NI2 raises an indication of non-idleness to central transponder circuit 150, causing a transition to link wake state 615. Subsequently, central transponder circuit 150 sends link wakeup requests 620A-D. After negotiations between the network elements associated with each link, each network element enters link up state 630. The link status is communicated to central transponder circuit 150. If all four link statuses indicate “link up,” wakeup flow proceeds to unlock state 640 for 130.NS1.

Once unlock state 640 is reached, central transponder circuit may instruct the follower transponder circuit for 130.NI2 to unlock, resulting in that network element entering unlock state 650 for 130.NI2. This may be referred to as a “downstream” wakeup flow. Note that a separate similar instruction (not pictured) may also occur with 130.NI1, causing that network element to also enter an unlocked state. This may be referred to as an “upstream” wakeup flow. When each of network elements 130 pictured in FIG. 6 enters an unlocked state, they each subsequently enter a respective ungate state 670, followed by a respective resume state 680, which allows traffic to again travel on the associated links.

To recap, FIGS. 1-6 have disclosed an apparatus that includes a computer system formed on one or more co-packaged integrated circuits. The computer system includes a plurality of agent circuits and a network circuit configured to convey information between various ones of the plurality of agent circuits. Exemplary agent circuits include one or more instances of any of the following agent circuits: central processing unit (CPU) circuits, graphics processing unit (GPU) circuits, memory controller circuits, and input/output (I/O) agent circuits, The network circuit includes a plurality of network circuit elements coupled via a plurality of links to define a network topology having respective network paths between pairs of the plurality of agent circuits. Exemplary network circuit elements include network interface circuits coupling respective agent circuits to the network circuit and network switch circuits.

The network circuit may also include a transponder subsystem configured to 1) deactivate links of the plurality of links based on determinations of network inactivity for network paths that utilize those links; and 2) activate deactivated links in a particular network path based on an indication of network activity for a first pair of agent circuits that utilize the particular network path. The computer system is further configured to reduce power to links that have been deactivated.

The transponder subsystem may be configured to receive indications of whether particular ones of the respective network paths are idle, and, in response to receiving an indication of idleness for every one of a set of network paths utilizing a given link, is configured to send an instruction to lock each of the set of network paths, thereby preventing the set of network paths from receiving network traffic until unlocked. Further, the transponder subsystem may be configured to send an instruction to deactivate the given link after the given link is locked, and to disable clock inputs and then disable power inputs to power domains that include links that have been deactivated.

In some embodiments, the transponder subsystem, after sending commands to activate all links in the particular network path, is configured to unlock the particular network path to permit traffic over the particular network path.

In some implementations, the transponder subsystem includes a central transponder circuit and a plurality of follower transponder circuits, the central transponder circuit being configured to communicate with follower transponders circuits for both ends of a particular link being locked or unlocked. In some embodiments, the central transponder circuit may include a lock finite state machine for each network path in the network circuit and a teardown finite state machine for each of the plurality of links.

The transponder subsystem can scale in some embodiments to include two or more central transponder circuits corresponding to different parts of the network circuit. The two or more central transponder circuits may be located on a single integrated circuit die in some systems, while in other systems, the two or more central transponder circuits may include a first central transponder circuit located on a first integrated circuit die and a second central transponder circuit located on a second integrated circuit die.

The description of FIGS. 1-6 has primarily focused on embodiments in which network circuit 120 includes a single central transponder circuit 150 that manages link deactivation and activation for all links within network circuit 120. Other embodiments to be described with respect to FIGS. 7-10 allow a scalable solution for different network topologies and sizes. These solutions utilize multiple central transponder circuits 150. This approach enables an efficient design approach that allows pattern duplication and reuse of common physical circuits blocks. Such an approach may also reduce the number of physical wires emanating from the central transponder circuit, relative to an approach in which only a single central transponder circuit is employed.

FIG. 7A is a block diagram of one embodiment of a network circuit in which multiple central transponder circuits are located on a single integrated circuit die. As depicted, network circuit 120 includes two central transponder circuits 150A-B, both located on a single integrated circuit die (indicated as Die 0). This approach may be employed, for example, when network circuit 120 reaches a size in which the use of a single central transponder circuit becomes problematic (e.g., from a physical layout or performance standpoint). In the arrangement shown in FIG. 7A, for example, central transponder circuit 150A may interface with network elements in a first portion of network circuit 120 (commonly a portion most adjacent to central transponder circuit 150A), while central transponder circuit 150B may interface with network elements in a different portion of network circuit 120. The follower transponder circuits 250 for network circuit 120 are not shown for simplicity.

Note that while two central transponder circuits 150 are shown in FIG. 7A, any suitable number of these central transponder circuits may be employed depending on the size of the network circuit 120 in a particular design. Generally speaking, in designs with larger numbers of agent circuits (e.g., more processing circuits, GPUs, etc.), more central transponder circuits may be needed to perform segmented (i.e., link-based) clock and power gating.

FIG. 7B is a block diagram of one embodiment of a network circuit located on two different integrated circuit dies, each having a corresponding central transponder circuit. The multiple central transponder circuit paradigm may thus be extended to multiple integrated circuit dies. FIG. 7B depicts an embodiment in which each integrated circuit die includes a single central transponder circuit, but in other embodiments, each integrated circuit die could each have multiple central transponder circuits.

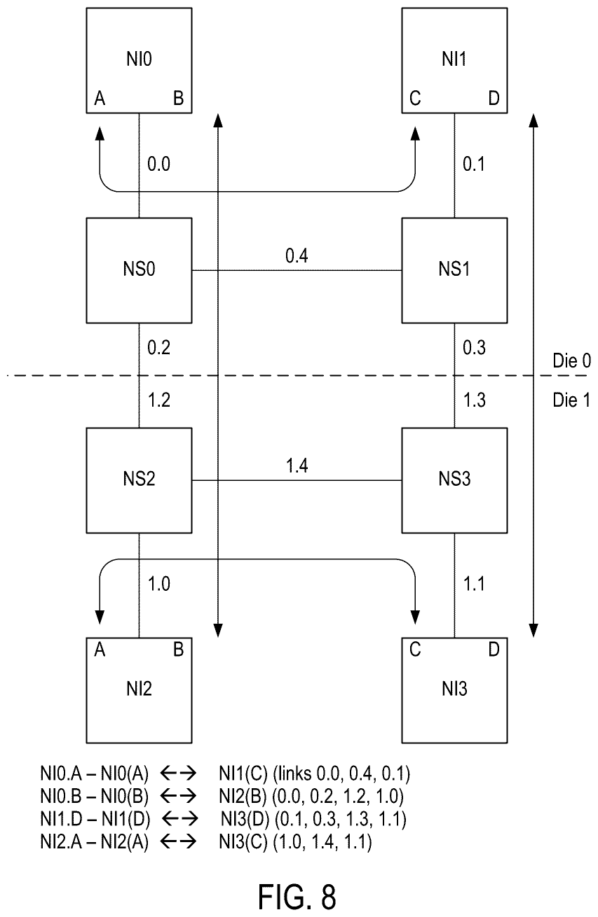

The general functionality of central transponder circuit 150 described with respect to FIGS. 1-6 applies to multiple central transponder circuit embodiments, although some cross-central transponder communication is needed to ensure correctness since a given network path may cross domains of multiple central transponder circuits. These extensions with respect to the single central transponder embodiment are described with respect to FIGS. 8-10.

FIG. 8 illustrates an example embodiment of a network circuit with network paths spanning multiple integrated circuit dies (dies 0 and 1). This example will be used to explain functionality of the multiple central transponder embodiments in subsequent figures. Four network interface circuits are depicted: NI0, NI1, N2, and N3, which correspond to instances of network interfaces 130.NI described with respect to previous figures. Note that various ports A-D are enumerated for network interfaces on each die. Four network switches are also depicted: NS0, NS1, NS2, and NS3 (similarly corresponding to instances of network switches 130.NS previously described).

Note that a given network interface can communicate some other network interfaces, but not others, in this topology of network circuit 120. Four network paths are illustrated. First, there is a path between port A of NI0 and port C of NI1, utilizing links 0.0 (i.e., die0.link 0), 0.4, and 0.1. Second is the path between port B of NI0 and port B of NI2, utilizing links 0.0, 0.2, 1.2, and 1.0. Third, there is a path between port D of NI1 and port D of NI3, utilizing links 0.1, 0.3, 1.3, and 1.1. Finally, there is a path between port A of NI2 and port C of NI3, utilizing links 1.0, 1.4, and 1.1

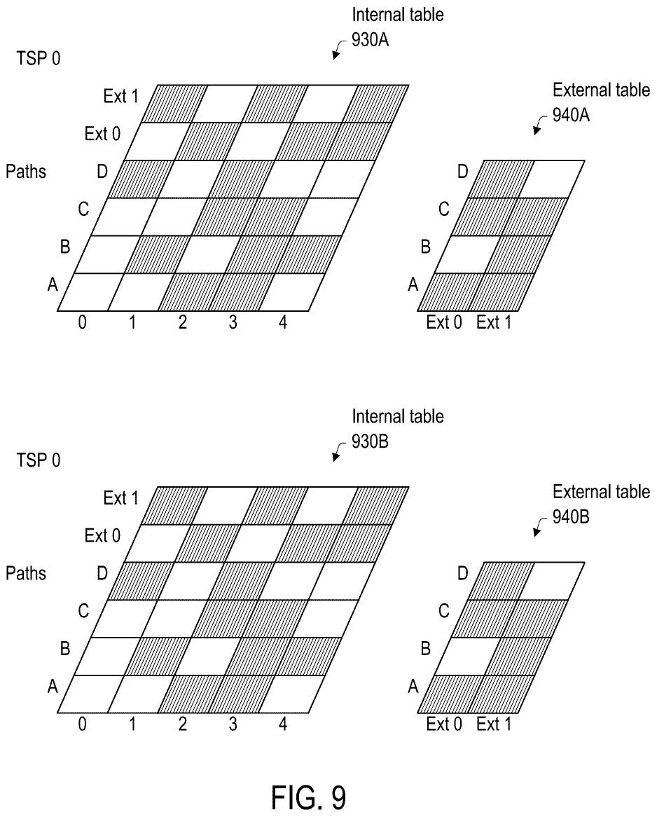

FIG. 9 depicts tables illustrating operation of one embodiment of a multiple central transponder subsystem. FIG. 9 depicts two tables for each of two central transponder circuits: internal tables 930A-B (for TSP 0 and 1, respectively) and external tables 940A-B. These tables implement the network topology shown in FIG. 8. Internal table 930A shows links that are utilized within die 0, while internal table 930B shows links that are utilized within die 1. As will be explained, external tables 940A-B are utilized when a particular network path spans multiple dies. Note that the discussion of this Figure also applies to a scenario in which multiple central transponder circuits are utilized within a single die.

Consider the column of table 930A corresponding to port A of TSP0, which is associated with NI0. As depicted, links 0.0, 0.1, and 0.4 are valid for this network path. Because this path is solely within die 0, neither entry in external table 940A is set. Now consider the column of table 930 corresponding to port B, which is also associated with NI0. As depicted, links 0.0 and 0.2 are valid for this network path. But because this path spans dies 0 and 1, external table 940A is utilized by setting the EXT0 entry to a valid state. As will be described, TSP0 can provide an indication of EXT0 to TSP1 concerning this path. In response, TSP1 can consult the portion of internal table 940A corresponding to EXT0. In other words, TSP1 can consult the EXT0 portion when it is signaled by TSP0. As can be seen, the valid links indicated in the EXT0 portion of table 940B are 1.0 and 1.2. Note that because there are two network paths that span dies 0 and 1 (originating from ports B and D), external tables 940 include two rows. In general, external tables 940 can be as large as needed according to the topology of network circuit 120.

Internal table 930B works identically to internal table 930A, as can be seen from columns B and D, which have entries set in external table 940B. Because of the particular topology of FIG. 8, tables 930A-B and 940A-B are identical to one another. But in other network topologies, this will not necessarily be the case.

Table 930A is utilized in the same manner as table 330 described above with respect to FIG. 3C. A particular column in table 930A indicates which links in die 0 are valid for a particular path. When all paths for a particular link are idle, those paths may all be locked. But as will be described below, path locking does not occur until the central transponders have communicated with one another to make sure that portions of a particular network path located in a region of network circuit 120 for a different central transponder circuit are also idle.

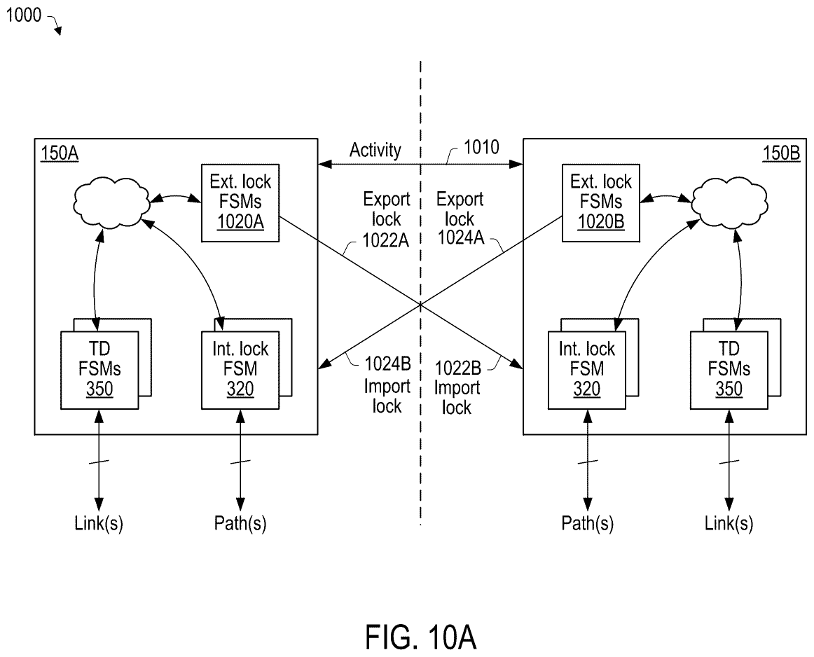

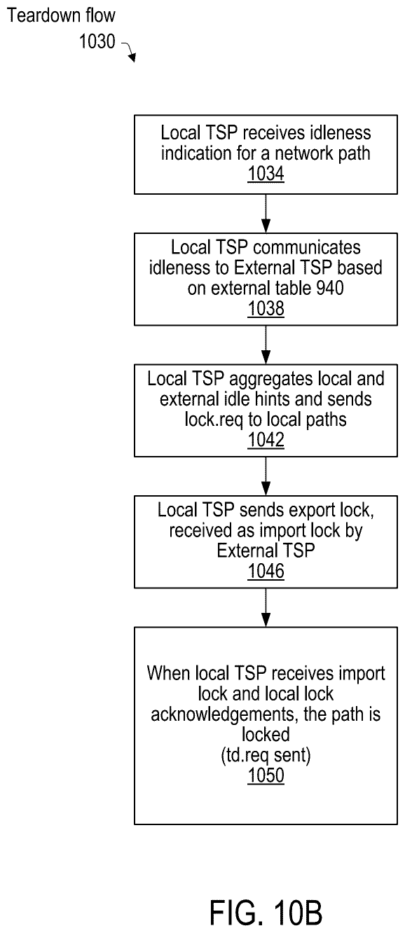

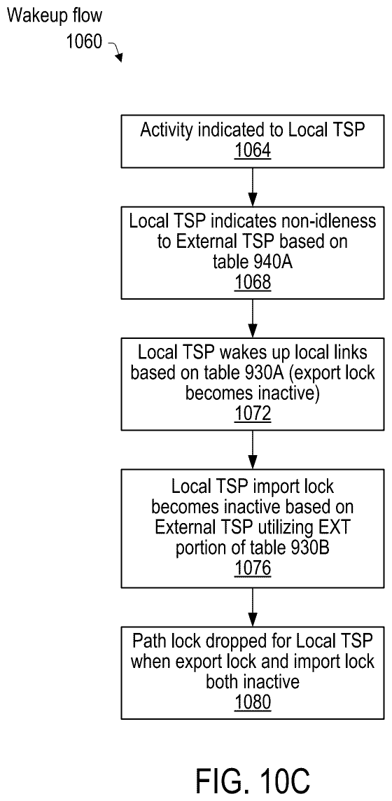

FIG. 10A is a block diagram of one embodiment of a transponder subsystem with multiple central transponder circuits. As depicted, computer system 1000 includes central transponder circuits 150A-B. A given central transponder circuit 150 includes internal lock FSMs 320 and TD FSMs 350, which operate similarly to how those entities were described with respect to FIG. 3A. Additionally, a given central transponder circuit 150 includes an external lock FSM 1020, which is responsible for communicating with the other central transponder circuit. External lock FSM 1020A is configured to send export lock signal 1022A to central transponder circuit 150B, where it is received as import lock signal 1022B. Similarly, external lock FSM 1020B is configured to send export lock signal 1024A to central transponder circuit 150A, where it is received as import lock signal 1024B.

As will be described, the communication of lock signals between central transponder circuits 150 is used to indicate when a lock is requested for a network path that spans portions of network circuit belonging to different central transponder circuits. Central transponder circuits 150 are also configured to communicate activity information 1010. Using the tables described with respect to FIG. 9, central transponder circuit 150A may send activity information 1010 indicating idleness or non-idleness of the network path corresponding to EXT0. Central transponder circuit 150B can then utilize the information in the column of internal table 940B corresponding to EXT0.

Example teardown and wakeup flows for the multiple central transponder embodiments are now described with respect to FIGS. 10B-C.

FIG. 10B is a flow diagram of one embodiment of a method for a teardown flow for a transponder subsystem with multiple central transponder circuits. Teardown flow 1030 is described with respect to a local transponder circuit (“Local TSP”) and an external transponder circuit (“External TSP”). The steps of teardown flow are all performed by the Local TSP.

Teardown flow 1030 begins in 1034, in which Local TSP receives an idleness indication for a network path. In various embodiments, this idleness indication may originate within the Local TSP in some scenarios, and with the External TSP in other scenarios. In 1038, the Local TSP communicates idleness to the External TSP based on external table 940. For example, if the path for column B in FIG. 9 is idle, EXT0 is communicated to the External TSP via activity information 1010. In 1042, the Local TSP aggregates local and external idle hints and sends lock requests to local paths. In 1046, the Local TSP sends an export lock signal, which is received as an import lock signal by the External TSP. (Note that 1046 may be done in parallel with 1042, such that sending the export lock may be done at the same time as the local lock requests.) Subsequently, in 1050, the Local TSP will itself receive an import lock signal from the External TSP. Once local lock acknowledgements are also received, the Local TSP will signal that the network path is locked, which permits link teardown to commence.

FIG. 10C is a flow diagram of one embodiment of a method for a wakeup flow for a transponder subsystem with multiple central transponder circuits. As with teardown flow 1030 described above with respect to FIG. 10B, wakeup flow 1060 is described with respect to a Local TSP and an External TSP.

Wakeup flow begins in 1064, in which activity (i.e., non-idleness) is indicated to the Local TSP. In 1068, the Local TSP indicates non-idleness to the External TSP based on table 940A. In 1072, the Local TSP wakes up local links based on table 930A, and the export lock signal of the Local TSP becomes inactive (e.g., deasserted) after the External TSP wakes up its own link as a result of receiving an indication of non-idleness from the Local TSP. The Local TSP is configured to wake up the local links in parallel with indicating non-idleness to the External TSP. In 1076, the import lock signal for the Local TSP becomes inactive based on the External TSP utilizing the EXT portion of table 930B to wakeup links in the portion of network circuit 120 corresponding to the External TSP. Finally, in 1080, the path lock signal (e.g., 156) becomes inactive based on the export lock and import lock signals for the Local TSP becoming inactive. When a lock signal 156 is no longer active for a particular network path that spans portions of a network circuit having multiple central transponder circuits, network traffic can then resume on that network path.

To recap, an apparatus has been described with respect to FIGS. 7-10 that includes a computer system formed on one or more co-packaged integrated circuits, the computer system including a plurality of agent circuits and a network circuit configured to convey information between various ones of the plurality of agent circuits. The plurality of agent circuits may include one or more instances of any of the following types of agent circuits: central processing unit (CPU) circuits, graphics processing unit (GPU) circuits, memory controller circuits, and input/output (I/O) agent circuits. The network circuit includes, in one embodiment, a plurality of network circuit elements coupled via a plurality of links to define a network topology having respective network paths between pairs of the plurality of agent circuits, as well as a transponder subsystem including multiple central transponder circuits. Examples of network circuit elements include network interface circuits coupling respective agent circuits to the network circuit and network switch circuits.

Each of the multiple central transponder circuits is configured to deactivate links of the plurality of links based on determinations of network inactivity for agent circuits that utilize those links, and to activate deactivated links in a particular network path based on an indication of network activity for a first pair of agent circuits that utilize the particular network path.

The multiple central transponder circuits include, in one embodiment, a first central transponder circuit configured to manage activation and deactivation of links in a first portion of the network circuit, and a second central transponder circuit configured to manage activation and deactivation of links in a second, different portion of the network circuit. The computer system is configured to reduce power to links that have been deactivated. With respect to a given link that has been deactivated, the computer system is configured to disable clock inputs and power inputs on a power domain that includes the given link.

The first and second central transponder circuits are configured, in some embodiments, to perform a handshake protocol in order to lock a particular network path that spans the first and second portions of the network circuit, thereby preventing the particular network path from receiving network traffic until unlocked. Based on locking of the particular network path, the first central transponder circuit is configured to deactivate links in the particular network path that are located in the first portion of the network circuit and the second central transponder circuit is configured to deactivate links in the particular network path that are located in the second portion of the network circuit. The first and second central transponder circuits are configured to perform a handshake protocol in order to unlock a particular network path that spans the first and second portions of the network circuit, permitting links in the particular network path to be reactivated. The sending of an export lock signal and the receiving of an import lock request is one example of such a handshake protocol.

In some embodiments, the transponder subsystem includes a plurality of follower transponder circuits, a given one of the multiple central transponder circuits being configured to communicate with follower transponders circuits for both ends of a particular link being locked or unlocked. A given one of the multiple central transponder circuits in the transponder subsystem may include a lock finite state machine for each network path in a respective portion of the network circuit corresponding to the given central transponder circuit, as well as a teardown finite state machine for each link in the respective portion of the network circuit.

In some embodiments, the first portion and the second portion of the network circuit are both located on a single integrated circuit die. In other embodiments, the first portion of the network circuit and the first central transponder circuit are both located on a first integrated circuit die, and the second portion of the network circuit and the second central transponder circuit are both located on a second integrated circuit die coupled to the first integrated circuit die. In other embodiments, there may be multiple central transponder circuits located on each of multiple integrated circuit dies. In general, this approach allows scalability, both for different network sizes and for multi-die implementations.

Another apparatus has been described that includes a computer system formed on one or more co-packaged integrated circuits that includes a plurality of agent circuits and a network circuit configured to convey information between various ones of the plurality of agent circuits. The network circuit includes, for example, a plurality of network circuit elements coupled via a plurality of links to define a network topology having respective network paths between pairs of the plurality of agent circuits, including a particular network path that includes a first link located in a first portion of the network circuit and a second link located in a second, different portion of the network circuit.

The network circuit also includes a transponder subsystem having a first central transponder circuit corresponding to the first portion of the network circuit and a second central transponder circuit corresponding to the second portion of the network circuit. The first central transponder circuit is configured to send, to the second central transponder circuit, a first indication of network inactivity for a first set of network paths that include the first link, while the second central transponder circuit is configured to send, to the first central transponder circuit, a second indication of network inactivity for a second set of network paths that include the second link. Accordingly, based on a handshake protocol that includes receipt of the first indication by the second central transponder circuit and receipt of the second indication by the first central transponder circuit, the transponder subsystem is configured to deactivate the first link and the second link.

Additionally, the computer system is configured, after deactivating the first link and the second link, to disable clock and power inputs for power domains that include the first link and the second link. To reactivate the particular network path based on an indication of activity for the particular network path occurring in the first portion of the network circuit, the first central transponder circuit is configured to activate deactivated links for the particular network path that are located in the first portion of the network circuit, including the first link. The first central transponder circuit is also configured to send, to the second central transponder circuit, an indication to activate deactivated links for the particular network path, including the second link, that are located in the second portion of the network circuit.

To reactivate the particular network path based on an indication of activity for the particular network path occurring in the second portion of the network circuit, the first central transponder circuit is configured to receive, from the second central transponder circuit, an indication to activate deactivated links for the particular network path, including the first link, that are located in the first portion of the network circuit. The first central transponder circuit is further configured to activate, based on the received indication, deactivated links for the particular network path that are located in the first portion of the network circuit, including the first link.

The transponder subsystem embodiments described herein have primarily been described with respect to dynamic link management of network circuit 120. But in various embodiments, transponder subsystem 148 may perform additional functions. For example, central transponder circuits may perform harvesting of network circuit blocks by masking communication with disabled circuit blocks.

“Harvesting” refers to various methods for configuring a computer system in accordance with a particular system/computing platform in which it is to be used. Computer systems can be manufactured to incorporate a wide variety of different functions. Furthermore, companies that manufacture various electronic devices may sometimes employ a common computer architecture across a wide variety of platforms. For example, a common computer architecture (including a common instruction set architecture, or ISA, for processing circuitry therein) may be employed on a range of platforms that include smartwatches, mobile computing devices (e.g., tablet, smartphones), set top boxes for televisions, laptop and desktop computers, server systems, and so on. These different platforms may have varying functional requirements despite the common computer architecture. For example, while a smartphone may include a camera that utilizes an image processing system, a set top box utilizing the same architecture may have no need to perform any image processing.

At the end of a manufacturing process, integrated circuits undergo testing to verify their functionality. In some cases, certain circuit blocks, such as network elements, may fail testing. But failure of some circuit blocks does not necessarily render unusable a particular instance of the integrated circuit. For example, failures in certain portions of network circuit 120, particularly those portions coupled to agent circuits not utilized in a particular computing platform, does not render an IC unusable. Instances of an IC that remain usable despite some failing circuit blocks may use programmable registers to disable the failing circuit blocks. This may prevent these circuit blocks from receiving any power, and may also prevent them from receiving a clock signal. By disabling them from receiving power and/or clock signals, these functional circuit blocks may thus be inhibited from inadvertently generating any signals that could adversely affect operation of other circuit blocks that are fully functional. Furthermore, disabling an unused functional circuit block by inhibiting power from being provided thereto may reduce static power consumption by the IC.

Thus, in some embodiments, transponder subsystem 148 may be configured to perform link management for portions of network circuit 120 by deactivating links that have been harvested and that are not used in a particular instance of an IC.

Additionally, transponder subsystem 148 may provide graceful software power down for links and network paths. In other words, in addition to the dynamic management of links and network paths described herein, transponder subsystem 148 can allow for receipt of a software indication to turn off certain links and network paths. Such a shutdown is said to be “graceful” in that it is a controlled shutdown, meaning any needed state is saved, such that there is no unexpected data loss. During a software power down, a central transponder circuit can be configured to ignore any dynamic wakeup trigger (e.g., hints of non-idleness) that occur during the software power down. Once the software power down is ended, transponder subsystem 148 can resume normal operation.

Transponder subsystem 148 can also be configured with debug features, such as supporting the forceful wakeup of certain specified link and unlocking the corresponding network paths. Transponder subsystem 148 may also be programmed with certain survivability features, such as configurable teardown-disable properties. Consider a scenario in which dynamic link management bugs are present. Central transponder circuits 150 may support configuration information to disable lock and teardown sequences in view of such bugs.

### Example Methods

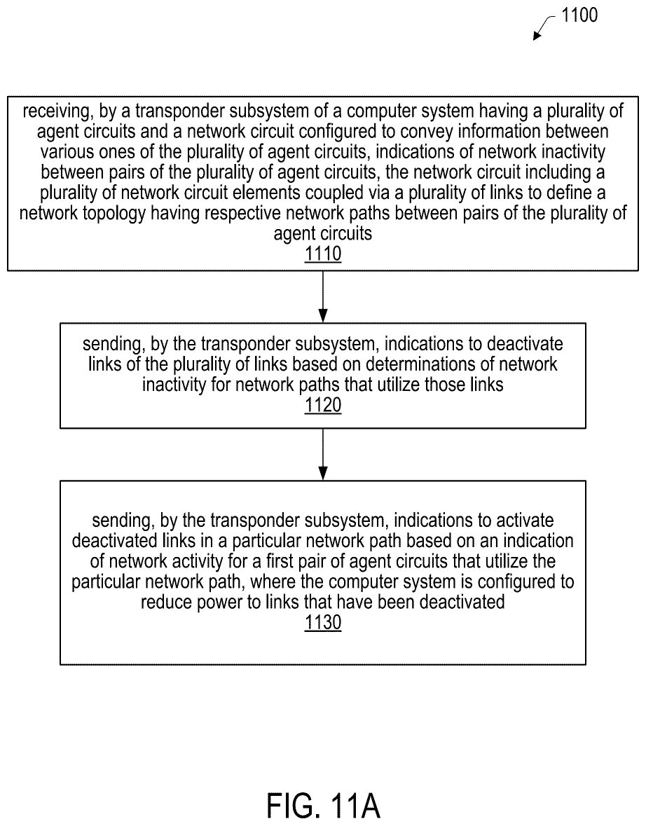

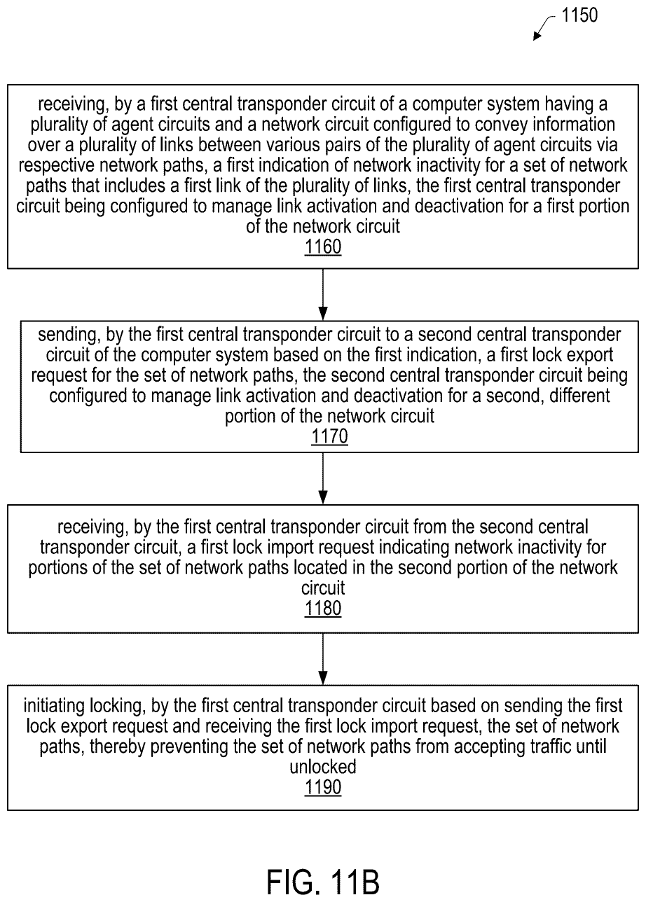

FIG. 11A is a flow diagram of one embodiment of a method 1100 for using a transponder subsystem to manage activity of a network circuit of a computer system. Method 1100 is thus written from the perspective of a transponder subsystem. Exemplary reference numerals to previously described structure and elements are provided for convenience in the following description of method 1100. Such reference numerals, however, are not intended to unduly limit the scope of this method.

Method 1100 begins in 1110, in which a transponder subsystem (148) of a computer system receives indications of network inactivity between pairs of a plurality of agent circuits (110). In addition to the plurality of agent circuits, the computer system includes a network circuit (120) configured to convey information between various ones of the plurality of agent circuits. The network circuit includes a plurality of network circuit elements (130) coupled via a plurality of links to define a network topology having respective network paths between pairs of the plurality of agent circuits.

In 1120, the transponder subsystem sends indications to deactivate links of the plurality of links (144) based on determinations of network inactivity for network paths (140) that utilize those links. In 1130, the transponder subsystem sends indications to activate deactivated links in a particular network path based on an indication of network activity for a first pair of agent circuits that utilize the particular network path. The computer system is configured to reduce power to links that have been deactivated.

In some embodiments, method 1100 may further include the transponder subsystem receiving indications of idleness (152) for every one of a set of network paths utilizing a given link, and sending, in response to the received indications, instructions to lock (156) each of the set of network paths. As noted, when a path is “locked” it is prevented from receiving network traffic until that path is unlocked. The transponder subsystem may send an instruction to deactivate (154) the given link after the given link is locked. The computer may then reduce power to links that have been deactivated by disabling clock and power inputs to power domains that include links that have been deactivated.

The transponder subsystem may subsequently send commands to activate all links in a particular network path, and unlock the particular network path to permit traffic over the particular network path. Sending indications to deactivate or activate links in the network circuit may include communication between a central transponder circuit and follower transponder circuits corresponding to the links being deactivated or activated. In some embodiments, sending indications to deactivate or activate links in the network circuit includes communication between multiple central transponder circuits that manage different portions of the network circuit, the multiple central transponder circuits all being located on a single integrated circuit die. In other embodiments, sending indications to deactivate or activate links in the network circuit includes communication between multiple central transponder circuits that manage different portions of the network circuit, wherein the multiple central transponder circuits are located two or more integrated circuit dies.

FIG. 11B is a flow diagram of one embodiment of another method 1150 for using a transponder subsystem to manage activity of a network circuit of a computer system. Method 1150 is written from the perspective of a transponder subsystem that has multiple central transponder circuits. Exemplary reference numerals to previously described structure and elements are provided for convenience in the following description of method 1150. Such reference numerals, however, are not intended to unduly limit the scope of this method.

Method 1150 begins in 1160, which is performed by a first central transponder circuit (150A) of a computer system having a plurality of agent circuits (110) and a network circuit (120). The network circuit is configured to convey information over a plurality of links between various pairs of the plurality of agent circuits via respective network paths. The first central transponder circuit receives a first indication of network inactivity for a set of network paths that includes a first link of the plurality of links (144), the first central transponder circuit being configured to manage link activation and deactivation for a first portion of the network circuit.

Method 1150 continues in 1170, in which the first central transponder circuit sends to a second central transponder circuit (150B) of the computer system based on the first indication, a first lock export request (1022A) for the set of network paths. The second central transponder circuit is configured to manage link activation and deactivation for a second, different portion of the network circuit. In 1180, the first central transponder circuit receives, from the second central transponder circuit, a first lock import request (1024B) indicating network inactivity for portions of the set of network paths located in the second portion of the network circuit. Finally, in 1190, the first central transponder circuit initiates, based on sending the first lock export request and receiving the first lock import request, locking of the set of network paths, thereby preventing the set of network paths from accepting traffic until unlocked. In some embodiments, method 1150 may further include, after the set of network paths are locked, 1) deactivating the first link, and 2) disabling, after the first link is deactivated, clock and power inputs for a power domain that includes the first link.

Method 1150 may include the first central transponder circuit performing a series of steps to wake up based on a local indication. This series of steps may include 1) receiving a local indication of activity for a particular network path of the set of network paths; 2) activating, based on the local indication, the links associated with the particular network path; 3) sending, after the activating, a second lock export request to the second central transponder circuit; 4) receiving a second lock import request from the second central transponder circuit; and 5) initiating unlocking the particular network path based on sending the second lock export request and receiving the second lock import request. Similarly, method 1150 may include performing a different series of steps to wake up based on an external indication. This different series of steps may include 1) receiving a second lock import request for a particular network path of the set of network paths; 2) activating, based on the second lock import request, the links associated with the particular network path; 3) sending, after the activating, a second lock export request to the second central transponder circuit; and 4) initiating unlocking the particular network path based on receiving the second lock import request and sending the second lock export request, the unlocking permitting the particular network path to receive network traffic.

In some embodiments, the first portion and the second portion of the network circuit are both located on a single integrated circuit, the first portion including the first central transponder circuit, and the second portion including the second central transponder circuit. In other embodiments, the network circuit is located on a plurality of integrated circuit dies that includes a first integrated circuit die and a second integrated circuit die. The first integrated circuit die includes the first portion of the network circuit and the first central transponder circuit, and the second integrated circuit die includes the second portion of the network circuit and the second central transponder circuit.

### Example Device

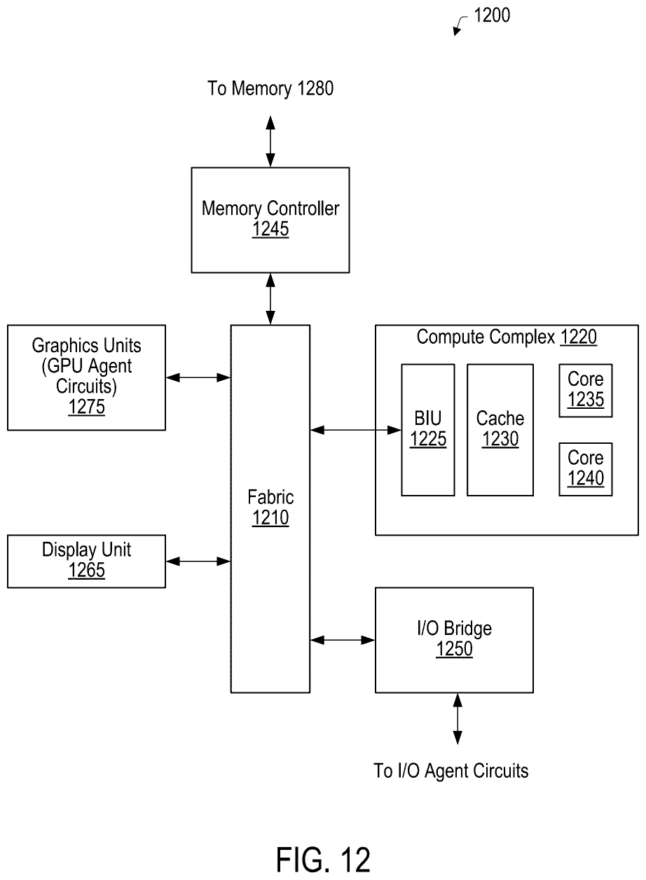

Referring now to FIG. 12, a block diagram illustrating an example embodiment of a device 1200 is shown. In some embodiments, elements of device 1200 may be included within a system-on-a-chip or distributed on multiple co-packaged integrated circuits as part of a chiplet architecture. In some embodiments, device 1200 may be included in a mobile device, which may be battery powered. Therefore, power consumption by device 1200 may be an important design consideration. In the illustrated embodiment, device 1200 includes fabric 1210, compute complex 1220 input/output (I/O) bridge 1250, memory controller 1245, graphics unit 1275, and display unit 1265. In some embodiments, device 1200 may include other components (not shown) in addition to or in place of the illustrated components, such as video processor encoders and decoders, image processing or recognition elements, computer vision elements, etc.

Fabric 1210 may include various interconnects, buses, multiplexers, controllers, etc., and may be configured to facilitate communication between various elements of device 1200. In some embodiments, portions of fabric 1210 may be configured to implement various different communication protocols. In other embodiments, fabric 1210 may implement a single communication protocol and elements coupled to fabric 1210 may convert from the single communication protocol to other communication protocols internally.

In the illustrated embodiment, compute complex 1220 includes bus interface unit (BIU) 1225, cache 1230, and cores 1235 and 1240. In various embodiments, compute complex 1220 may include various numbers of processors, processor cores and caches. For example, compute complex 1220 may include 1, 2, or 4 processor cores, or any other suitable number. In one embodiment, cache 1230 is a set associative L2 cache. In some embodiments, cores 1235 and 1240 may include internal instruction and data caches. In some embodiments, a coherency unit (not shown) in fabric 1210, cache 1230, or elsewhere in device 1200 may be configured to maintain coherency between various caches of device 1200. BIU 1225 may be configured to manage communication between compute complex 1220 and other elements of device 1200. Processor cores such as cores 1235 and 1240 may be configured to execute instructions of a particular instruction set architecture (ISA) which may include operating system instructions and user application instructions. These instructions may be stored in computer readable medium such as a memory coupled to memory controller 1245 discussed below.

As used herein, the term “coupled to” may indicate one or more connections between elements, and a coupling may include intervening elements. For example, in FIG. 12, graphics unit 1275 may be described as “coupled to” a memory through fabric 1210 and memory controller 1245. In contrast, in the illustrated embodiment of FIG. 12, graphics unit 1275 is “directly coupled” to fabric 1210 because there are no intervening elements.

Memory controller 1245 may be configured to manage transfer of data between fabric 1210 and one or more caches and memories. In various embodiments, memory controller 1245 may be coupled to an L3 cache, which may in turn be coupled to a system memory. In other embodiments, memory controller 1245 may be directly coupled to a memory. In some embodiments, memory controller 1245 may include one or more internal caches. Memory 1280 coupled to memory controller 1245 may be any type of volatile memory, such as dynamic random access memory (DRAM), synchronous DRAM (SDRAM), double data rate (DDR, DDR2, DDR3, etc.) SDRAM (including mobile versions of the SDRAMs such as mDDR3, etc., and/or low power versions of the SDRAMs such as LPDDR4, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with an integrated circuit in a chip-on-chip configuration, a package-on-package configuration, or a multi-chip module configuration. Memory coupled to memory controller 1245 may also be any type of non-volatile memory such as NAND flash memory, NOR flash memory, nano RAM (NRAM), magneto-resistive RAM (MRAM), phase change RAM (PRAM), Racetrack memory, Memristor memory, etc. As noted above, this memory may store program instructions executable by compute complex 1220 to cause the computing device to perform functionality described herein.

Graphics unit 1275 may include one or more processors, e.g., one or more graphics processing units (GPUs). Graphics unit 1275 may receive graphics-oriented instructions, such as OPENGL®, Metal®, or DIRECT3D® instructions, for example. Graphics unit 1275 may execute specialized GPU instructions or perform other operations based on the received graphics-oriented instructions. Graphics unit 1275 may generally be configured to process large blocks of data in parallel and may build images in a frame buffer for output to a display, which may be included in the device or may be a separate device. Graphics unit 1275 may include transform, lighting, triangle, and rendering engines in one or more graphics processing pipelines. Graphics unit 1275 may output pixel information for display images. Graphics unit 1275, in various embodiments, may include programmable shader circuitry which may include highly parallel execution cores configured to execute graphics programs, which may include pixel tasks, vertex tasks, and compute tasks (which may or may not be graphics-related).

Display unit 1265 may be configured to read data from a frame buffer and provide a stream of pixel values for display. Display unit 1265 may be configured as a display pipeline in some embodiments. Additionally, display unit 1265 may be configured to blend multiple frames to produce an output frame. Further, display unit 1265 may include one or more interfaces (e.g., MIPI® or embedded display port (eDP)) for coupling to a user display (e.g., a touchscreen or an external display).

I/O bridge 1250 may include various elements configured to implement: universal serial bus (USB) communications, security, audio, and low-power always-on functionality, for example. I/O bridge 1250 may also include interfaces such as pulse-width modulation (PWM), general-purpose input/output (GPIO), serial peripheral interface (SPI), and inter-integrated circuit (I2C), for example. Various types of peripherals and devices may be coupled to device 1200 via I/O bridge 1250.

In some embodiments, device 1200 includes network interface circuitry (not explicitly shown), which may be connected to fabric 1210 or I/O bridge 1250. The network interface circuitry may be configured to communicate via various networks, which may be wired, wireless, or both. For example, the network interface circuitry may be configured to communicate via a wired local area network, a wireless local area network (e.g., via Wi-Fi™), or a wide area network (e.g., the Internet or a virtual private network). In some embodiments, the network interface circuitry is configured to communicate via one or more cellular networks that use one or more radio access technologies. In some embodiments, the network interface circuitry is configured to communicate using device-to-device communications (e.g., Bluetooth® or Wi-Fi™ Direct), etc. In various embodiments, the network interface circuitry may provide device 1200 with connectivity to various types of other devices and networks.

As has been described previously, various elements within device 1200 may exist in different power domains. For example, one domain may include the various components coupled to fabric 1210, as well as a portion of memory controller 1245. Another domain may include a portion of memory controller 1245 that interfaces to memory 1280.

### Agent Circuits

Agent circuits are circuits that implement functionality for agents within a device such as that shown in FIG. 12. As has been described throughout this disclosure, an agent is any component or device (e.g., processor, peripheral, memory controller, etc.) that sources and/or sinks communications on one or more of networks (e.g., fabric 1210). A source agent circuit generates (sources) a communication, and a destination agent circuit receives (sinks) the communication. A given agent circuit may be a source agent for some communications and a destination agent for other communications.

As used herein, a “processor circuit” refers to any type of central processing unit (CPU). A given processor circuit can include multiple CPUs. For example, one implementation might include a single component with one processing element (i.e., one processor core). Another implementation might include a single component with multiple processor cores (e.g., cores 1235 and 1240). Yet another implementation might include a processor cluster with multiple components, each of which may include multiple processor cores.

“Memory controllers,” on the other hand refer to any circuit that interfaces to system memory, which includes DRAM. Some embodiments of memory controllers may include memory caches, while others may not. Agent circuits shown in FIG. 12, for example, are able to access memory controller 1245 using fabric 1210.

In one embodiment, components such as display unit 1265 or those coupled to fabric 1210 via I/O bridge 1250 may be referred to as SoC agents. Some of these SoC agents may also be considered to be input/output (I/O) devices or I/O agents, a broad category that can include an internal or external display, one or more cameras (including associated image signal processor circuits), a Smart IO circuit, and interfaces to various buses such as USB and PCIe. Such circuits can thus be considered to be both SoC agents and I/O agent circuits, where I/O agent circuits are a subset of SoC agents. Other types of SoC agent circuits are possible, including a secure enclave processor, a neural processing engine, JPEG codec circuits, video encoding/decoding circuits, a power manager circuit, an always-on (AON) circuit, etc. Such circuits may thus be SoC agent circuits but not I/O agent circuits.

GPUs such as graphics unit 1275 are another type of agent circuit. In some embodiments, GPUs may also be connected to agent circuits acting as memory controllers, allowing GPUs to access system memory via fabric 710.

### Example Applications

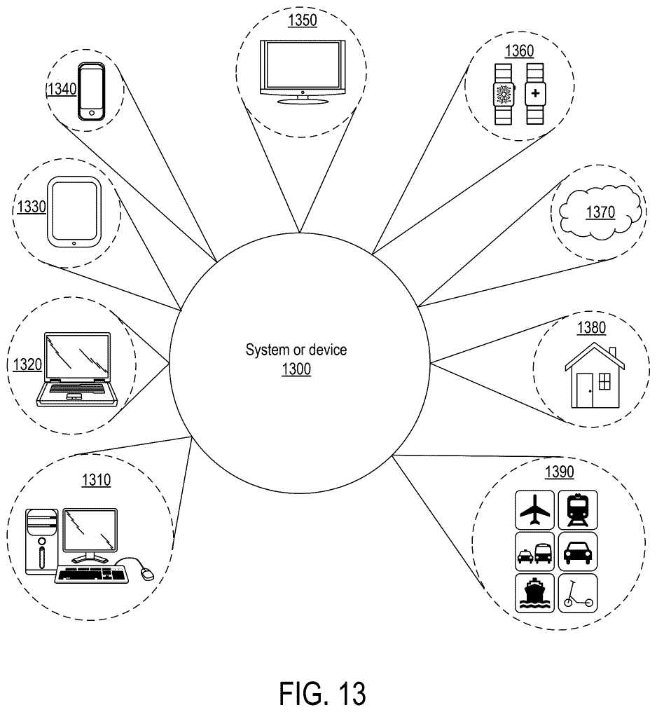

Turning now to FIG. 13, various types of systems that may include any of the circuits, devices, or system discussed above. System or device 1300, which may incorporate or otherwise utilize one or more of the techniques described herein, may be utilized in a wide range of areas. For example, system or device 1300 may be utilized as part of the hardware of systems such as a desktop computer 1310, laptop computer 1320, tablet computer 1330, cellular or mobile phone 1340, or television 1350 (or set-top box coupled to a television).

Similarly, disclosed elements may be utilized in a wearable device 1360, such as a smartwatch or a health-monitoring device. Smartwatches, in many embodiments, may implement a variety of different functions—for example, access to email, cellular service, calendar, health monitoring, etc. A wearable device may also be designed solely to perform health-monitoring functions, such as monitoring a user's vital signs, performing epidemiological functions such as contact tracing, providing communication to an emergency medical service, etc. Other types of devices are also contemplated, including devices worn on the neck, devices implantable in the human body, glasses or a helmet designed to provide computer-generated reality experiences such as those based on augmented and/or virtual reality, etc.

System or device 1300 may also be used in various other contexts. For example, system or device 1300 may be utilized in the context of a server computer system, such as a dedicated server or on shared hardware that implements a cloud-based service 1370. Still further, system or device 1300 may be implemented in a wide range of specialized everyday devices, including devices 1380 commonly found in the home such as refrigerators, thermostats, security cameras, etc. The interconnection of such devices is often referred to as the “Internet of Things” (IoT). Elements may also be implemented in various modes of transportation. For example, system or device 1300 could be employed in the control systems, guidance systems, entertainment systems, etc. of various types of vehicles 1390.

The applications illustrated in FIG. 13 are merely exemplary and are not intended to limit the potential future applications of disclosed systems or devices. Other example applications include, without limitation: portable gaming devices, music players, data storage devices, unmanned aerial vehicles, etc.

### Example Computer-Readable Medium

The present disclosure has described various example circuits in detail above. It is intended that the present disclosure cover not only embodiments that include such circuitry, but also a computer-readable storage medium that includes design information that specifies such circuitry. Accordingly, the present disclosure is intended to support claims that cover not only an apparatus that includes the disclosed circuitry, but also a storage medium that specifies the circuitry in a format that programs a computing system to generate a simulation model of the hardware circuit, programs a fabrication system configured to produce hardware (e.g., an integrated circuit) that includes the disclosed circuitry, etc. Claims to such a storage medium are intended to cover, for example, an entity that produces a circuit design, but does not itself perform complete operations such as: design simulation, design synthesis, circuit fabrication, etc.

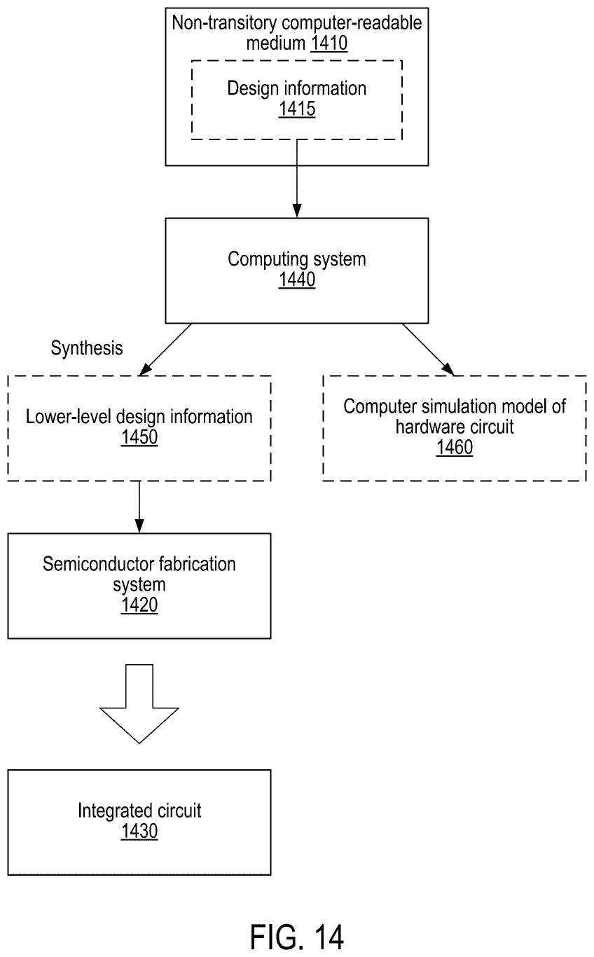

FIG. 14 is a block diagram illustrating an example non-transitory computer-readable storage medium that stores circuit design information, according to some embodiments. In the illustrated embodiment, computing system 1440 is configured to process the design information. This may include executing instructions included in the design information, interpreting instructions included in the design information, compiling, transforming, or otherwise updating the design information, etc. Therefore, the design information controls computing system 1440 (e.g., by programming computing system 1440) to perform various operations discussed below, in some embodiments.

In the illustrated example, computing system 1440 processes the design information to generate both a computer simulation model 1460 of a hardware circuit and lower-level design information 1450. In other embodiments, computing system 1440 may generate only one of these outputs, may generate other outputs based on the design information, or both. Regarding the computing simulation, computing system 1440 may execute instructions of a hardware description language that includes register transfer level (RTL) code, behavioral code, structural code, or some combination thereof. The simulation model may perform the functionality specified by the design information, facilitate verification of the functional correctness of the hardware design, generate power consumption estimates, generate timing estimates, etc.

In the illustrated example, computing system 1440 also processes the design information to generate lower-level design information 1450 (e.g., gate-level design information, a netlist, etc.). This may include synthesis operations, as shown, such as constructing a multi-level network, optimizing the network using technology-independent techniques, technology dependent techniques, or both, and outputting a network of gates (with potential constraints based on available gates in a technology library, sizing, delay, power, etc.). Based on lower-level design information 1450 (potentially among other inputs), semiconductor fabrication system 1420 is configured to fabricate an integrated circuit 1430 (which may correspond to functionality of the simulation model 1460). Note that computing system 1440 may generate different simulation models based on design information at various levels of description, including information 1450, 1415, and so on. The data representing design information 1450 and model 1460 may be stored on medium 1410 or on one or more other media.

In some embodiments, the lower-level design information 1450 controls (e.g., programs) the semiconductor fabrication system 1420 to fabricate the integrated circuit 1430. Thus, when processed by the fabrication system, the design information may program the fabrication system to fabricate a circuit that includes various circuitry disclosed herein.

Non-transitory computer-readable storage medium 1410, may comprise any of various appropriate types of memory devices or storage devices. Non-transitory computer-readable storage medium 1410 may be an installation medium, e.g., a CD-ROM, floppy disks, or tape device; a computer system memory or random access memory such as DRAM, DDR RAM, SRAM, EDO RAM, Rambus RAM, etc. ; a non-volatile memory such as a Flash, magnetic media, e.g., a hard drive, or optical storage; registers, or other similar types of memory elements, etc. Non-transitory computer-readable storage medium 1410 may include other types of non-transitory memory as well or combinations thereof. Accordingly, non-transitory computer-readable storage medium 1410 may include two or more memory media; such media may reside in different locations—for example, in different computer systems that are connected over a network.

Design information 1415 may be specified using any of various appropriate computer languages, including hardware description languages such as, without limitation: VHDL, Verilog, SystemC, SystemVerilog, RHDL, M, MyHDL, etc. The format of various design information may be recognized by one or more applications executed by computing system 1440, semiconductor fabrication system 1420, or both. In some embodiments, design information may also include one or more cell libraries that specify the synthesis, layout, or both of integrated circuit 1430. In some embodiments, the design information is specified in whole or in part in the form of a netlist that specifies cell library elements and their connectivity. Design information discussed herein, taken alone, may or may not include sufficient information for fabrication of a corresponding integrated circuit. For example, design information may specify the circuit elements to be fabricated but not their physical layout. In this case, design information may be combined with layout information to actually fabricate the specified circuitry.

Integrated circuit 1430 may, in various embodiments, include one or more custom macrocells, such as memories, analog or mixed-signal circuits, and the like. In such cases, design information may include information related to included macrocells. Such information may include, without limitation, schematics capture database, mask design data, behavioral models, and device or transistor level netlists. Mask design data may be formatted according to graphic data system (GDSII), or any other suitable format.

Semiconductor fabrication system 1420 may include any of various appropriate elements configured to fabricate integrated circuits. This may include, for example, elements for depositing semiconductor materials (e.g., on a wafer, which may include masking), removing materials, altering the shape of deposited materials, modifying materials (e.g., by doping materials or modifying dielectric constants using ultraviolet processing), etc. Semiconductor fabrication system 1420 may also be configured to perform various testing of fabricated circuits for correct operation.

In various embodiments, integrated circuit 1430 and model 1460 are configured to operate according to a circuit design specified by design information 1415, which may include performing any of the functionality described herein. For example, integrated circuit 1430 may include any of various elements shown in FIGS. 1-10. Further, integrated circuit 1430 may be configured to perform various functions described herein in conjunction with other components. Further, the functionality described herein may be performed by multiple connected integrated circuits.

As used herein, a phrase of the form “design information that specifies a design of a circuit configured to . . . ” does not imply that the circuit in question must be fabricated in order for the element to be met. Rather, this phrase indicates that the design information describes a circuit that, upon being fabricated, will be configured to perform the indicated actions or will include the specified components. Similarly, stating “instructions of a hardware description programming language” that are “executable” to program a computing system to generate a computer simulation model” does not imply that the instructions must be executed in order for the element to be met, but rather specifies characteristics of the instructions. Additional features relating to the model (or the circuit represented by the model) may similarly relate to characteristics of the instructions, in this context. Therefore, an entity that sells a computer-readable medium with instructions that satisfy recited characteristics may provide an infringing product, even if another entity actually executes the instructions on the medium.

Note that a given design, at least in the digital logic context, may be implemented using a multitude of different gate arrangements, circuit technologies, etc. As one example, different designs may select or connect gates based on design tradeoffs (e.g., to focus on power consumption, performance, circuit area, etc.). Further, different manufacturers may have proprietary libraries, gate designs, physical gate implementations, etc. Different entities may also use different tools to process design information at various layers (e.g., from behavioral specifications to physical layout of gates).

Once a digital logic design is specified, however, those skilled in the art need not perform substantial experimentation or research to determine those implementations. Rather, those of skill in the art understand procedures to reliably and predictably produce one or more circuit implementations that provide the function described by the design information. The different circuit implementations may affect the performance, area, power consumption, etc. of a given design (potentially with tradeoffs between different design goals), but the logical function does not vary among the different circuit implementations of the same circuit design.

In some embodiments, the instructions included in the design information instructions provide RTL information (or other higher-level design information) and are executable by the computing system to synthesize a gate-level netlist that represents the hardware circuit based on the RTL information as an input. Similarly, the instructions may provide behavioral information and be executable by the computing system to synthesize a netlist or other lower-level design information. The lower-level design information may program fabrication system 1420 to fabricate integrated circuit 1430.

The present disclosure includes references to an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of task or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom-designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement of such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used to transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits or portions thereof may also be custom designed in a schematic editor and captured into the integrated circuit design along with synthesized circuitry. The integrated circuits may include transistors and other circuit elements (e.g., passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

What is claimed is:

1. An apparatus, comprising:
a computer system formed on one or more co-packaged integrated circuits, the computer system including:
a plurality of agent circuits;
a network circuit configured to convey information between various ones of the plurality of agent circuits, wherein the network circuit includes:
a plurality of network circuit elements coupled via a plurality of links to define a network topology having respective network paths between pairs of the plurality of agent circuits; and
a transponder subsystem configured to:
deactivate links of the plurality of links based on determinations of network inactivity for network paths that utilize those links; and
activate deactivated links in a particular network path based on an indication of network activity for a first pair of agent circuits that utilize the particular network path; and
wherein the computer system is configured to reduce power to links that have been deactivated.

2. The apparatus of claim 1, wherein the plurality of agent circuits includes one or more instances of any of the following agent circuits:
central processing unit (CPU) circuits, graphics processing unit (GPU) circuits, memory controller circuits, and input/output (I/O) agent circuits, and wherein the plurality of network circuit elements includes 1) network interface circuits coupling respective agent circuits to the network circuit and 2) network switch circuits.

3. The apparatus of claim 1, wherein the transponder subsystem is configured to receive indications of whether particular ones of the respective network paths are idle.

4. The apparatus of claim 3, wherein the transponder subsystem, in response to receiving an indication of idleness for every one of a set of network paths utilizing a given link, is configured to send an instruction to lock each of the set of network paths, thereby preventing the set of network paths from receiving network traffic until unlocked.

5. The apparatus of claim 4, wherein the transponder subsystem is configured to send an instruction to deactivate the given link after the given link is locked.

6. The apparatus of claim 1, wherein the computer system is configured to disable clock inputs and then disable power inputs to power domains that include links that have been deactivated.

7. The apparatus of claim 1, wherein the transponder subsystem, after sending commands to activate all links in the particular network path, is configured to unlock the particular network path to permit traffic over the particular network path.

8. The apparatus of claim 1, wherein the transponder subsystem includes a central transponder circuit and a plurality of follower transponder circuits, the central transponder circuit being configured to communicate with follower transponder circuits for both ends of a particular link being locked or unlocked.

9. The apparatus of claim 1, wherein the transponder subsystem includes a central transponder circuit that includes:
a lock finite state machine for each network path in the network circuit; and
a teardown finite state machine for each of the plurality of links.

10. The apparatus of claim 1, wherein the transponder subsystem is configured to perform link management for portions of the network circuit by deactivating links that have been harvested and that are not used in a particular instance of an IC.

11. The apparatus of claim 1, wherein the transponder subsystem is configured to:
receive a software indication to turn off a particular link or particular network path in the network circuit;
save any state associated with the particular link or particular network path; and
perform a shutdown for the particular link or particular network path such that there is no unexpected data loss, ignoring any dynamic wakeup triggers associated with the particular link or network path during the shutdown.

12. The apparatus of claim 1, wherein the transponder subsystem is configured to:
support forceful wakeup of a specified link and unlocking of a corresponding network path that includes the specified link; and
disable, based on configuration information, lock and teardown sequences to enable link management debugging.

13. A method, comprising:
receiving, by a transponder subsystem of a computer system having a plurality of agent circuits and a network circuit configured to convey information between various ones of the plurality of agent circuits, indications of network inactivity between pairs of the plurality of agent circuits, the network circuit including a plurality of network circuit elements coupled via a plurality of links to define a network topology having respective network paths between pairs of the plurality of agent circuits;
sending, by the transponder subsystem, indications to deactivate links of the plurality of links based on determinations of network inactivity for network paths that utilize those links; and
sending, by the transponder subsystem, indications to activate deactivated links in a particular network path based on an indication of network activity for a first pair of agent circuits that utilize the particular network path; and
wherein the computer system is configured to reduce power to links that have been deactivated.

14. The method of claim 13, further comprising, by the transponder subsystem:
receiving indications of idleness for every one of a set of network paths utilizing a given link; and
sending, in response to the received indications, instructions to lock each of the set of network paths, thereby preventing the set of network paths from receiving network traffic until unlocked.

15. The method of claim 14, further comprising the transponder subsystem sending an instruction to deactivate the given link after the given link is locked.

16. The method of claim 13, further comprising the computer system disabling clocking and power inputs to power domains that include links that have been deactivated.

17. The method of claim 13, further comprising the transponder subsystem:
sending commands to activate all links in the particular network path; and
unlocking the particular network path to permit traffic over the particular network path.

18. An apparatus, comprising:
a computer system formed on one or more co-packaged integrated circuits, the computer system including:
a plurality of agent circuits;
a network circuit configured to convey information between various ones of the plurality of agent circuits, wherein the network circuit includes:
a plurality of network circuit elements coupled via a plurality of links to define a network topology having respective network paths between pairs of the plurality of agent circuits; and
a transponder subsystem configured to:
maintain a table circuit that includes, for a given network path of a plurality of network paths in the network circuit, link status for all links in the given network path;
make a first determination, based on a first set of link statuses in the table circuit, that all network paths that utilize a first link are inactive;
deactivate, based on the first determination, the first link;
make a second determination, based on a second set of link statuses in the table circuit, that there is activity for a particular network path for a first pair of agent circuits; and
activate, based on the second determination, any deactivated links in the particular network path.

19. The apparatus of claim 18, wherein the transponder subsystem includes, for a given network path in the network circuit, a lock finite state machine configured to generate a lock signal to lock the given network path, and wherein the transponder subsystem further includes, for a given link in the network circuit, a teardown finite state machine configured to generate a teardown signal to teardown the given link.

20. The apparatus of claim 19, wherein the table circuit is configured to:
output, to the teardown finite state machine for the given link, an aggregate lock signal, wherein the aggregate lock signal is output based on link statuses in the table circuit indicating that every network path that utilizes the given link is inactive; and
output, to the lock finite state machine for the given network path, an unlocked signal, wherein the unlocked signal is output based on the table circuit indicating activity for the given network path.
